(19) United States
(12) Patent Application Publication
(10) Pub. No.: US 2022/0116967 A1
(43) Pub. Date: Apr. 14, 2022

(54) METHOD AND APPARATUS FOR TRANSMISSION AND RECEPTION USING NARROWBAND IN COMMUNICATIONS SYSTEM

(71) Applicant: Samsung Electronics Co., Ltd., Suwon-si (KR)

(72) Inventors: Jeongho YEO, Suwon-si (KR); Youngbum KIM, Suwon-si (KR); Sungjin PARK, Suwon-si (KR); Hyunseok RYU, Suwon-si (KR); Cheolkyu SHIN, Suwon-si (KR); Seunghoon CHOI, Suwon-si (KR)

(21) Appl. No.: 17/450,276

(22) Filed: Oct. 7, 2021

(30) Foreign Application Priority Data
Oct. 8, 2020 (KR) 10-2020-0130358

(51) Int. Cl. H04W 72/12; H04W 72/04

(52) U.S. Cl. CPC H04W 72/1268; H04W 72/0453; H04W 72/0446; H04W 72/1289

(57) ABSTRACT

The disclosure relates to a 5G or 6G communication system for supporting a higher data transmission rate after a 4G communication system such as LTE. In a communication system of the disclosure, a method of a UE includes: receiving configuration information for configuring resource allocation in units of sub-PRBs; receiving control information including resource allocation information in units of sub-PRBs; and transmitting and receiving data on the basis of the control information.

### CROSS-REFERENCE TO RELATED APPLICATIONS

This application is based on and claims priority under 35 U.S.C. § 119 to Korean Patent Application No. 10-2020-0130358, filed on Oct. 8, 2020, in the Korean Intellectual Property Office, the disclosure of which is herein incorporated by reference in its entirety.

### BACKGROUND

### 1. Field

The disclosure relates to a communication system and provides a method and an apparatus for increasing a transmission rate of data which a UE transmits to a BS, that is, uplink data or expanding a distance that a signal reaches.

### 2. Description of Related Art

A review of the development of mobile communication from generation to generation shows that the development has mostly been directed to technologies for services targeting humans, such as voice-based services, multimedia services, and data services. It is expected that connected devices which are exponentially increasing after commercialization of 5G communication systems will be connected to communication networks. Examples of things connected to networks may include vehicles, robots, drones, home appliances, displays, smart sensors connected to various infrastructures, construction machines, and factory equipment. Mobile devices are expected to evolve in various formfactors, such as augmented reality glasses, virtual reality headsets, and hologram devices. In order to provide various services by connecting hundreds of billions of devices and things in the 6G era, there have been ongoing efforts to develop improved 6G communication systems. For these reasons, 6G communication systems are referred to as Beyond-5G systems.

6G communication systems, which are expected to be implemented approximately by 2030, will have a maximum transmission rate of tera (1,000 giga)-level bps and a radio latency of 100 μsec, and thus will be 50 times as fast as 5G communication systems and have the 1/10 radio latency thereof.

In order to accomplish such a high data transmission rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, a technology capable of securing the signal transmission distance (that is, coverage) will become more crucial. It is necessary to develop, as major technologies for securing the coverage, multiantenna transmission technologies including radio frequency (RF) elements, antennas, novel waveforms having a better coverage than OFDM, beamforming and massive MIMO, full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the frequency efficiencies and system networks, the following technologies have been developed for 6G communication systems: a full-duplex technology for enabling an uplink (UE transmission) and a downlink (node B transmission) to simultaneously use the same frequency resource at the same time; a network technology for utilizing satellites, high-altitude platform stations (HAPS), and the like in an integrated manner; a network structure innovation technology for supporting mobile nodes B and the like and enabling network operation optimization and automation and the like; a dynamic spectrum sharing technology though collision avoidance based on spectrum use prediction, an artificial intelligence (AI)-based communication technology for implementing system optimization by using AI from the technology design step and internalizing end-to-end AI support functions; and a next-generation distributed computing technology for implementing a service having a complexity that exceeds the limit of UE computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between things and connections between humans and things. Particularly, it is expected that services such as truly immersive XR, high-fidelity mobile holograms, and digital replicas could be provided through 6G communication systems. In addition, with enhanced security and reliability, services such as remote surgery, industrial automation, and emergency response will be provided through 6G communication systems, and thus these services will be applied to various fields including industrial, medical, automobile, and home appliance fields.

In the late 2010s and in 2020s, companies providing communication services through satellites have increased according to a rapid decrease in satellite launch costs. Accordingly, a satellite network has emerged as a next-generation network system that compensates for the existing ground network. The satellite network may not provide a user experience at a ground network level, but may have an advantage of providing a communication service even in a region in which the ground network cannot be constructed or even in a disaster situation and also secure economic feasibility due to the rapid decrease in satellite launch costs at present as described above. Further, some companies and the 3rd Generation Partnership Project (3GPP) standard are researching direct communication between a smartphone and a satellite.

The above information is presented as background information only to assist with an understanding of the disclosure. No determination has been made, and no assertion is made, as to whether any of the above might be applicable as prior art with regard to the disclosure.

### SUMMARY

The disclosure provides a method and an apparatus for supporting data transmission and reception in units of narrow bandwidths (for example, sub-PRBs).

According to the disclosure, it is possible to efficiently use resources through narrow-bandwidth transmission and expand coverage of signal transmission and reception.

The present disclosure has been made to address the above-mentioned problems and disadvantages, and to provide at least the advantages described below.

In accordance with an aspect of the present disclosure, a method performed by a terminal in a communication system is provided. The method includes receiving, from a base station, configuration information on a sub physical resource block (sub-PRB) based transmission, the configuration information including at least one of a number of subcarriers for a resource unit or a number of slots in the resource unit; receiving, from the base station, downlink control information scheduling uplink data associated with the sub-PRB transmission; obtaining a transport block size (TBS) corresponding to the uplink data based on the configuration information; and transmitting, to the base station, the uplink data on a physical uplink shared channel (PUSCH), wherein the number of subcarriers for the resource unit is smaller than 12.

In accordance with another aspect of the present disclosure, a method performed by a base station in a communication system is provided. The method includes transmitting, to a terminal, configuration information on a sub physical resource block (sub-PRB) based transmission, the configuration information including at least one of a number of subcarriers for a resource unit or a number of slots in the resource unit; identifying a transport block size (TBS) corresponding to uplink data based on the configuration information; transmitting, to the terminal, downlink control information scheduling the uplink data associated with the sub-PRB transmission; and receiving, from the terminal, the uplink data on a physical uplink shared channel (PUSCH), wherein the number of subcarriers for the resource unit is smaller than 12.

In accordance with another aspect of the present disclosure, a terminal in a communication system is provided. The terminal includes a transceiver; and a controller coupled with the transceiver and configured to receive, from a base station, configuration information on a sub physical resource block (sub-PRB) based transmission, the configuration information including at least one of a number of subcarriers for a resource unit or a number of slots in the resource unit, receive, from the base station, downlink control information scheduling uplink data associated with the sub-PRB transmission, obtain a transport block size (TBS) corresponding to the uplink data based on the configuration information, and transmit, to the base station, the uplink data on a physical uplink shared channel (PUSCH), wherein the number of subcarriers for the resource unit is smaller than 12.

In accordance with another aspect of the present disclosure, a base station in a communication system is provided. The base station includes a transceiver; and a controller coupled with the transceiver and configured to transmit, to a terminal, configuration information on a sub physical resource block (sub-PRB) based transmission, the configuration information including at least one of a number of subcarriers for a resource unit or a number of slots in the resource unit, identify a transport block size (TBS) corresponding to uplink data based on the configuration information, transmit, to the terminal, downlink control information scheduling the uplink data associated with the sub-PRB transmission, and receive, from the terminal, the uplink data on a physical uplink shared channel (PUSCH), wherein the number of subcarriers for the resource unit is smaller than 12.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the disclosure and its advantages, reference is now made to the following description taken in conjunction with the accompanying drawings, in which like reference numerals represent like parts:

FIG. 1 illustrates the basic structure of a time-frequency domain that is a radio resource area in which data or a control channel is transmitted in a downlink or an uplink of an NR system;

FIG. 2 illustrates mapping of a synchronization signal (SS) and a physical broadcast channel (PBCH) in frequency and time domains in the NR system;

FIG. 3 illustrates symbols in which the SS/PBCH block can be transmitted according to subcarrier spacing;

FIG. 4 illustrates a control area in which a downlink control channel is transmitted in a 5G wireless communication system;

FIG. 5 illustrates an example of a process in which one transport block is divided into a plurality of code blocks and a CRC is added;

FIG. 6 illustrates a processing time of the UE according to timing advance when the UE receives a first signal and transmits a second signal in response thereto in the 5G or NR system according to various embodiments of the present disclosure;

FIG. 7 illustrates an example in which data (for example, TBs) are scheduled and transmitted according to a slot, HARQ-ACK feedback for the corresponding data is received, and retransmission is performed according to the feedback;

FIG. 8 illustrates an example of a communication system using a satellite;

FIG. 9 illustrates a period of revolution of the satellite around the earth according to an altitude or a height of the satellite;

FIG. 10 is a conceptual diagram illustrating direct communication between the satellite and the UE;

FIG. 11 illustrates a scenario using direct communication between the satellite and the UE;

FIG. 12 illustrates an example of calculation of expected data throughput in the uplink when the LEO satellite having an altitude of 1200 km and the UE on the ground perform direct communication;

FIG. 13 illustrates an example of calculation of expected data throughput in the uplink when the GEO satellite having an altitude of 35,786 km and the ground UE perform direct communication;

FIG. 14 illustrates a path loss value according to a path loss model between the UE and the satellite and a path loss according to a path loss model between the UE and a ground network communication BS;

FIG. 15 illustrates an equation of calculating an amount of the Doppler shift which a signal experiences and the result thereof when the signal transmitted from the satellite is received by a user on the ground according to an altitude and a location of the satellite, and a location of the user of the UE on the ground;

FIG. 16 illustrates a velocity of the satellite calculated at an altitude of the satellite;

FIG. 17 illustrates Doppler shift which different UEs in one beam which a satellite transmits to the ground experience;

FIG. 18 illustrates difference between Doppler shifts generated within one beam according to a location of the satellite determined by an elevation angle;

FIG. 19 illustrates a delay time from the UE to the satellite according to the location of the satellite determined by the elevation angle and a round-trip delay time between the UE, the satellite, and the BS;

FIG. 20 illustrates a maximum difference value in the round-trip delay time varying depending on the location of the user within one beam;

FIG. 21 illustrates an example of the information structure of the RAR;

FIG. 22 illustrates an example of the relation between PRACH preamble configuration resources and an RAR reception time point in the LTE system;

FIG. 23 illustrates an example of the relation between PRACH preamble configuration resources and an RAR reception time point in the 5G NR system;

FIG. 24 illustrates an example of timing of a downlink frame and an uplink frame for the UE;

FIG. 25 illustrates an example of continuous movement of a satellite with respect to the ground of the earth or a UE located on the earth according to revolution of the satellite along a satellite orbit around the earth;

FIG. 26 illustrates an example of the structure of an artificial satellite;

FIG. 27 illustrates an example of PUSCH repetition transmission type B in the 5G or NR system;

FIG. 28 illustrates an example of a repetitive transmission type B of second uplink transmission in a TDD system;

FIG. 29 illustrates an example of resource allocation in units of RBs and in units of sub-PRBs;

FIG. 30A illustrates an example of the UE operation according to various embodiments of the present disclosure;

FIG. 30B illustrates an example of the BS operation according to various embodiments of the present disclosure;

FIG. 31 is a block diagram schematically illustrating the internal structure of the UE according to various embodiments of the present disclosure;

FIG. 32 is a block diagram schematically illustrating the internal structure of the satellite according to various embodiments of the present disclosure;

FIG. 33 is a block diagram schematically illustrating the internal structure of the BS according to various embodiments of the present disclosure;

FIG. 34 schematically illustrates the structure of the BS according to embodiments of the present disclosure; and

FIG. 35 schematically illustrates the structure of the UE according to embodiments of the present disclosure.

### DETAILED DESCRIPTION

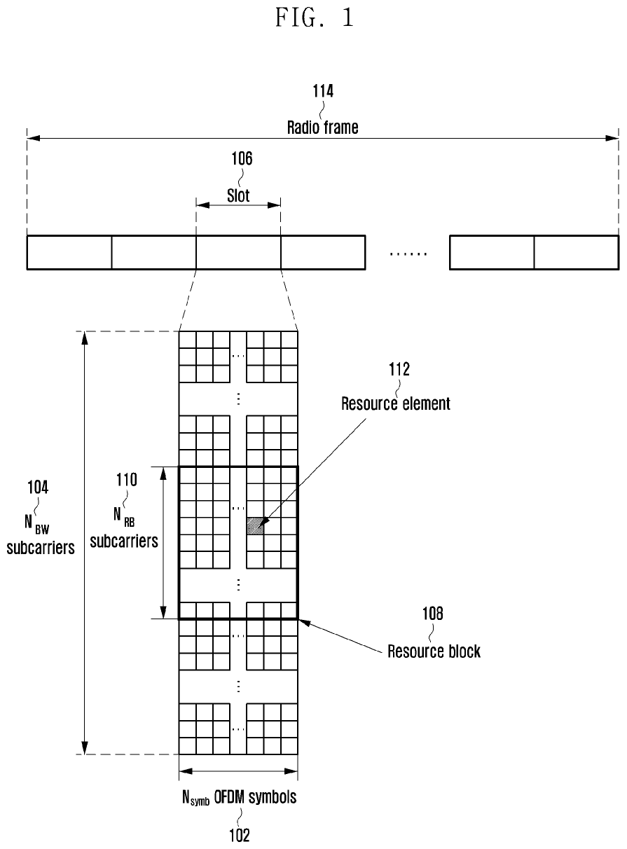

FIGS. 1 through 35, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

New radio access technology (NR) that is new 5G communication is designed to freely multiplex various services in time and frequency resources, and accordingly waveform/numerology and reference signals may be dynamically or freely allocated according to a need of the corresponding service. In order to provide an optimal service to the UE in wireless communication, optimized data transmission through measurement of a channel quality and an amount of interference is important, and thus it is necessary to accurately measure a channel state. However, unlike 4G communication in which channel and interference characteristics are not largely changed according to frequency resources, channel and interference characteristics are largely changed according to a service in the case of a 5G channel, so that a subset of frequency resource groups (FRGs) for performing measurement according to divided services should be supported. Meanwhile, in the NR system, supported service types may be divided into categories such as enhanced mobile broadband (eMBB), massive machine type communications (mMTC), ultra-reliable and low-latency communications (URLLC), and the like. The eMBB may be a service aiming at high-speed transmission of high-capacity data, the mMTC may be a service aiming at minimization of UE power and access of a plurality of UEs, and the URLLC may be a service aiming at high reliability and low latency. Different requirements may be applied according to the type of service applied to the UE.

As described above, a plurality of services may be provided to a user in a communication system, and in order to provide the plurality of services to the user, a method of providing each service in the same time interval according to a characteristic thereof and an apparatus using the same are needed.

Hereinafter, embodiments of the disclosure will be described in detail with reference to the accompanying drawings.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Further, the “unit” in the embodiments may include one or more processors.

A wireless communication system has developed to be a broadband wireless communication system that provides a high speed and high quality packet data service, like the communication standards, for example, high-speed packet access (HSPA) of 3GPP, long-term evolution (LTE) or evolved universal terrestrial radio access (E-UTRA), LTE-advanced (LTE-A), high-rate packet data (HRPD) of 3GPP2, ultra-mobile broadband (UMB), and 802.16e of IEEE, or the like, beyond the voice-based service provided at the initial stage. Also, communication standard of 5G or New Radio (NR) is being developed as a 5G wireless communication system.

An orthogonal frequency division multiplexing (OFDM) scheme in the downlink (DL) and the uplink of the NR system is adopted as a representative example of the broadband wireless communication system. However, more specifically, a cyclic-prefix OFDM (CP-OFDM) scheme is adopted in the downlink, and two schemes including the CP-OFDM scheme and a discrete Fourier transform spreading OFDM (DFT-S-OFDM) scheme are adopted in the uplink. The uplink is a radio link through which the user equipment (UE) or a mobile station (MS) transmits data or a control signal to the base station (BS) (or gNode B), and the downlink is a radio link through which the BS transmits data or a control signal to the UE. In the multiple access schemes as described above, time-frequency resources for carrying data or control information are allocated and operated in a manner to prevent overlapping of the resources, i.e., to establish the orthogonality, between users, so as to identify data or control information of each user.

If decoding fails at the initial transmission, the NR system employs hybrid automatic repeat request (HARQ) of retransmitting the corresponding data in a physical layer. In the HARQ scheme, when a receiver does not accurately decode data, the receiver transmits information (negative acknowledge: NACK) informing the transmitter of decoding failure and thus the transmitter may re-transmit the corresponding data on the physical layer. The receiver may combine data retransmitted from the transmitter and previous data, the decoding of which failed, whereby data reception performance may increase. When the receiver accurately decodes data, the receiver transmits information (acknowledgement: ACK) informing the transmitter of decoding success and thus the transmitter may transmit new data.

FIG. 1 illustrates the basic structure of a time-frequency domain that is a radio resource area in which data or a control channel is transmitted in a downlink or an uplink of an NR system.

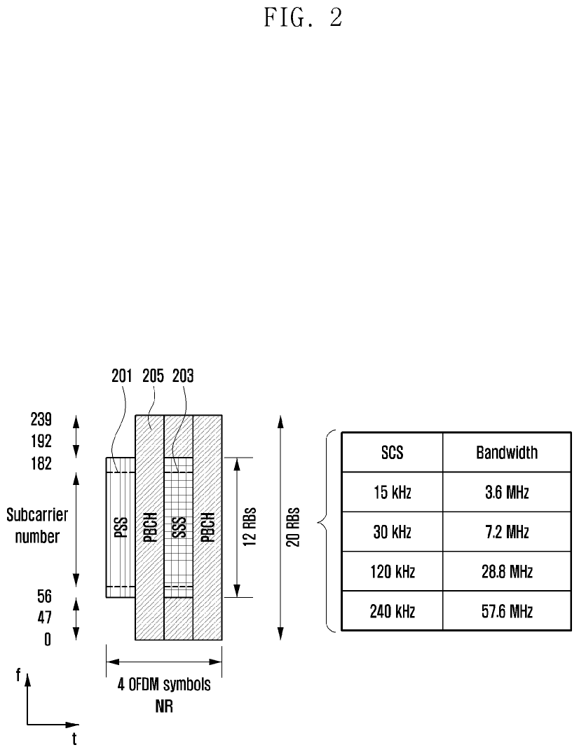

In FIG. 1, the horizontal axis indicates a time domain, and the vertical axis indicates a frequency domain. The minimum transmission unit in the time domain is an OFDM symbol, and N_{symb} OFDM symbols 102 are in one slot 106. The length of a subframe is defined as 1.0 ms and a radio frame 114 is defined as 10 ms. The minimum transmission unit in the frequency domain is a subcarrier, and a bandwidth of the entire system transmission band includes a total of N_{BW} subcarriers 104. One frame may be defined as 10 ms. One subframe may be defined as 1 ms, and thus one frame may include a total of ten subframes. One slot may be defined as 14 OFDM symbols (that is, the number (N_{symb}^{slot}) of symbols per slot=14). One subframe may include one or a plurality of slots, and the number of slots per subframe may vary depending on a configuration value for subcarrier spacing. In the example of FIG. 2, the cases in which the subcarrier spacing configuration value is and are illustrated. In the case of μ, one subframe may include one slot, and in the case of μ, one subframe may include two slots. That is, the number (Nₛₗₒₜ^{subframe}) of slots per subframe may vary depending on the configuration value μ for subcarrier spacing, and accordingly, the number (Nₛₗₒₜ^{frame,μ}) of slots per frame may vary. Nₛₗₒₜ^{subframe,μ} and Nₛₗₒₜ^{frame,μ} according to each subcarrier spacing configuration value may be defined as shown in [Table 1] below.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

A basic unit of resources in the time-frequency domain is a resource element (RE) 112 and may be indicated by an OFDM symbol index and a subcarrier index. A resource block (RB) 108 (or physical resource block (PRB)) is defined by NRB contiguous subcarriers 110 in the frequency domain. In general, the minimum transmission unit of data is the RB. In the NR system, generally, N_{symb}=14 and N_{RB}=12. N_{BW} is proportional to a bandwidth of a system transmission band. A data rate may increase in proportion to the number of RBs scheduled to the UE.

In the case of an FDD system, in which the downlink and the uplink are divided by the frequency in the NR system, a downlink transmission bandwidth and an uplink transmission bandwidth may be different from each other. A channel bandwidth refers to an RF bandwidth corresponding to a system transmission bandwidth. [Table 2] and [Table 3] show some of the corresponding relationships between a system transmission bandwidth, subcarrier spacing, and a channel bandwidth defined in the NR system in a frequency band lower than 6 GHz and a frequency band higher than 6 GHz. For example, the NR system having a channel bandwidth of 100 kHz with subcarrier spacing of 30 kHz includes a transmission bandwidth of 273 RBs. Hereinafter, N/A may be a combination of bandwidth-subcarrier that is not supported by the NR system.

TABLE 2

| | | | | 20 | 25 | 30 | 40 | 50 | 60 | 80 | 90 | 100 |
|---|---|---|---|---|---|---|---|---|---|---|---|---|
| SCS | 5 MHz | 10 MHz | 15 MHz | MHz | MHz | MHz | MHz | MHz | MHz | MHz | MHz | MHz |
| (kHz) | NRB | NRB | NRB | NRB | NRB | NRB | NRB | NRB | NRB | NRB | NRB | NRB |
| 15 | 25 | 52 | 79 | 106 | 133 | 160 | 216 | 270 | N/A | N/A | N/A | N/A |
| 30 | 11 | 24 | 38 | 51 | 65 | 78 | 106 | 133 | 162 | 217 | 245 | 273 |
| 60 | N/A | 11 | 18 | 24 | 31 | 38 | 51 | 65 | 79 | 107 | 121 | 135 |

TABLE 3

| Channel | | | | | |
|---|---|---|---|---|---|
| bandwidth | | | | | |
| BW_{channel} | Subcarrier | | | | |
| [MHz] | width | 50 MHz | 100 MHz | 200 MHz | 400 MHz |
| Transmission | 60 kHz | 66 | 132 | 264 | NA |
| bandwidth | 120 kHz | 32 | 66 | 132 | 264 |
| configuration | | | | | |
| N_{RB} | | | | | |

In the NR system, a frequency range may be defined to be divided into FR1 and FR2 as shown in [Table 4] below.

TABLE 4

| Frequency range | |
|---|---|
| designation | Corresponding frequency range |
| FR1 | 450 MHz-7125 MHz |
| FR2 | 24250 MHz-52600 MHz |

Ranges of FR1 and FR2 may be changed to other values and applied. For example, a frequency range of FR1 may be changed from 450 MHz to 600 MHz and applied.

Subsequently, a synchronization signal (SS)/PBCH block in a 5G system is described.

The SS/PBCH block may be a physical layer channel block including a primary SS (PSS), a secondary SS (SSS), and a PBCH. A detailed description thereof is made below.
PSS: is a signal which is a reference of downlink time/frequency synchronization and provides some pieces of information of a cell ID.
SSS: is a reference of downlink time/frequency synchronization and provides the remaining cell ID information which the PSS does not provide. In addition, the SSS serves as a reference signal for demodulation of a PBCH.
PBCH: provides necessary system information required for transmitting and receiving a data channel and a control channel by the terminal. The necessary system information may include control information related to a search space indicating radio resource mapping information of a control channel, scheduling control information for a separate data channel for transmitting system information, and the like.
SS/PBCH block: includes a combination of PSS, SSS, and PBCH. One or a plurality of SS/PBCH blocks may be transmitted within a time of 5 ms, and each of the transmitted SS/PBCH blocks may be separated by an index.

The UE may detect the PSS and the SSS in an initial access stage and decode the PBCH. The UE may acquire an MIB from the PBCH and receive a configuration of control resource set #0 (corresponding to a control resource set having a control resource set index of 0) therefrom. The UE may monitor control resource set #0 on the basis of the assumption that the selected SS/PBCH block and a demodulation reference signal (DMRS) transmitted in control resource set #0 are quasi co-located (QCLed). The UE may receive system information through downlink control information transmitted in control resource set #0. The UE may acquire configuration information related to a random access channel (RACH) required for initial access from the received system information. The UE may transmit a physical RACH (PRACH) to the BS in consideration of the selected SS/PBCH block index, and the BS receiving the PRACH may acquire the SS/PBCH block index selected by the UE. Through the process, the BS may know which block was selected from the SS/PBCH blocks by the UE and that the UE monitored control resource set #0 associated therewith.

FIG. 2 illustrates mapping of a synchronization signal (SS) and a physical broadcasting channel (PBCH) in the frequency and time domain of the NR system.

A primary synchronization signal (PSS) 201, a secondary synchronization signal (SSS) 203, and a PBCH 205 are mapped over 4 OFDM symbols, and the PSS and the SSS are mapped to 12 RBs and the PBCH is mapped to 20 RBs. A table in FIG. 2 shows how a frequency band of 20 RBs is changed according to Subcarrier Spacing (SCS). A resource area in which the PSS, the SSS, and the PBCH are transmitted may be called an SS/PBCH block. Further, the SS/PBCH block may be referred to as an SSB block.

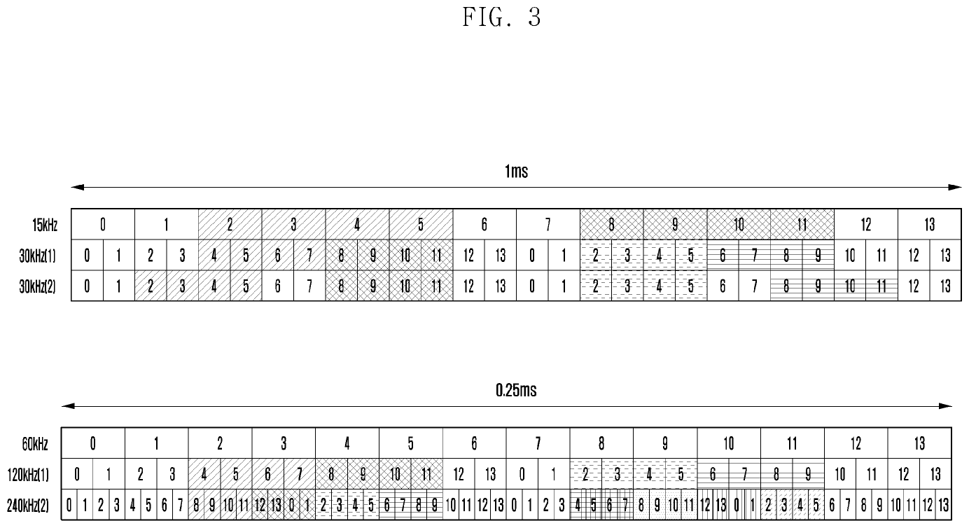

FIG. 3 illustrates symbols in which the SS/PBCH block can be transmitted according to subcarrier spacing.

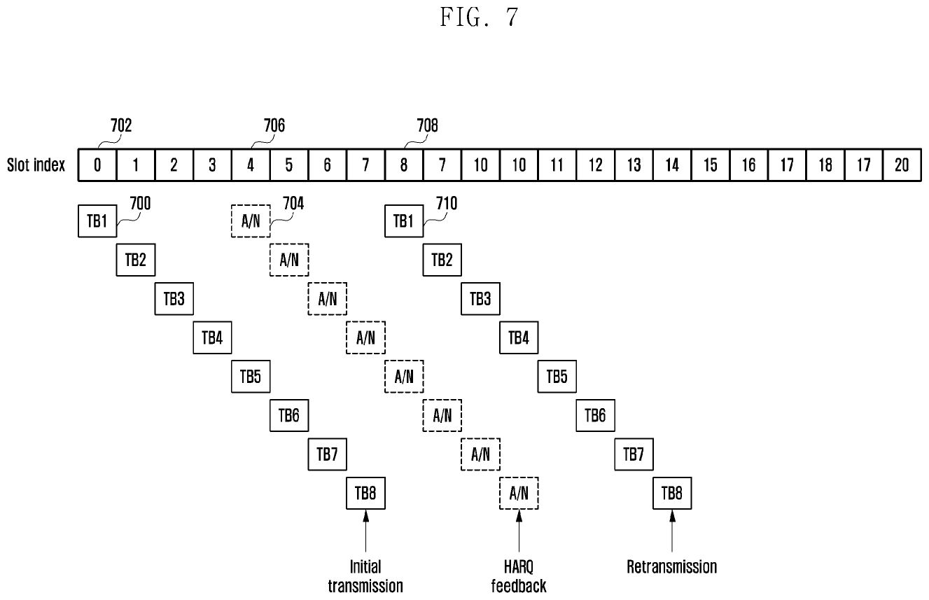

Referring to FIG. 3, subcarrier spacing may be configured as 15 kHz, 30 kHz, 120 kHz, 240 kHz, and the like, and the location of a symbol in which the SS/PBCH block (or SSB block) can be positioned may be determined according to each subcarrier spacing. FIG. 7 illustrates the location of symbols in which the SSB can be transmitted according to subcarrier spacing in symbols within 1 ms, and the SSB is not always transmitted in an area illustrated in FIG. 7. The location in which the SSB block is transmitted may be configured in the UE through system information or dedicated signaling.

The UE before the RRC connection may receive a configuration of an initial bandwidth part (initial BWP) for initial access from the BS through a master information block (MIB). More specifically, the UE may receive configuration information for a control resource set (CORESET) and a search space in which a physical downlink control channel (PDCCH) for receiving system information (remaining system information: RMSI or system information block 1: SIB1) required for initial access through the MIB can be transmitted in an initial access step. The control resource set and the search space configured as the MIB may be considered as an identity (ID) and 0, respectively. The BS may inform the UE of configuration information such as frequency allocation information for control resource set #0, time allocation information, numerology, and the like through the MIB. Further, the BS may inform the UE of configuration information for a monitoring period and an occasion of control resource set #0, that is, configuration information for search space #0 through the MIB. The UE may consider a frequency region configured as control resource set #0 acquired from the MIB as an initial bandwidth part for initial access. At this time, the ID of the initial BWP may be considered as 0.

The MIB may include the following information.

cellBarred: Value barred means that the cell is barred, as defined in TS 38.304.

dmrs-TypeA-Position: Position of (first) DM-RS for downlink (see TS 38.211) and uplink (see TS 38.211).

intraFreqReselection: Controls cell selection/reselection to intra-frequency cells when the highest ranked cell is barred, or treated as barred by the UE, as specified in TS 38.304.

pdcch-ConfigSIB1: Determines a common ControlResourceSet (CORESET), a common search space and necessary PDCCH parameters. If the field ssb-SubcarrierOffset indicates that SIB1 is absent, the field pdcch-ConfigSIB1 indicates the frequency positions where the UE may find SS/PBCH block with SIB1 or the frequency range where the network does not provide SS/PBCH block with SIB1 (see TS 38.213).

ssb-SubcarrierOffset: Corresponds to kSSB (see TS 38.213), which is the frequency domain offset between SSB and the overall resource block grid in number of subcarriers. (See TS 38.211).

The value range of this field may be extended by an additional most significant bit encoded within PBCH as specified in TS 38.213.

This field may indicate that this cell does not provide SIB1 and that there is hence no CORESET #0 configured in MIB (see TS 38.213). In this case, the field pdcch-ConfigSIB1 may indicate the frequency positions where the UE may (not) find a SS/PBCH with a control resource set and search space for SIB1 (see TS 38.213).

subCarrierSpacingCommon: Subcarrier spacing for SIB1, Msg.2/4 for initial access, paging and broadcast SI-messages. If the UE acquires this MIB on an FR1 carrier frequency, the value scs15or60 corresponds to 15 kHz and the value scs30or120 corresponds to 30 kHz. If the UE acquires this MIB on an FR2 carrier frequency, the value scs15or60 corresponds to 60 kHz and the value scs30or120 corresponds to 120 kHz.

systemFrameNumber: The 6 most significant bits (MSB) of the 10-bit system frame number (SFN). The 4 LSB of the SFN are conveyed in the PBCH transport block as part of channel coding (i.e., outside the MIB encoding), as defined in TS 38.212.

In a method of configuring the BWP, UEs before the RRC connection may receive configuration information for the initial BWP through the MIB in the initial access stage. More specifically, the UE may receive a configuration of a control resource set for a downlink control channel in which downlink control information (DCI) for scheduling a system information block (SIB) can be transmitted from an MIB of a physical broadcast channel (PBCH). At this time, a bandwidth of the control resource set configured as the MIB may be considered as an initial BWP, and the UE may receive a physical downlink shared channel (PDSCH) in which the SIB is transmitted through the configured initial BWP. The initial BWP may be used not only for reception of the SIB but also other system information (OSI), paging, or random access.

When one or more BWPs are configured in the UE, the BS may indicate a change in the BWPs to the UE through a BWP indicator field within the DCI.

Hereinafter, the downlink control channel in the 5G communication system will be described in more detail with reference to the drawings.

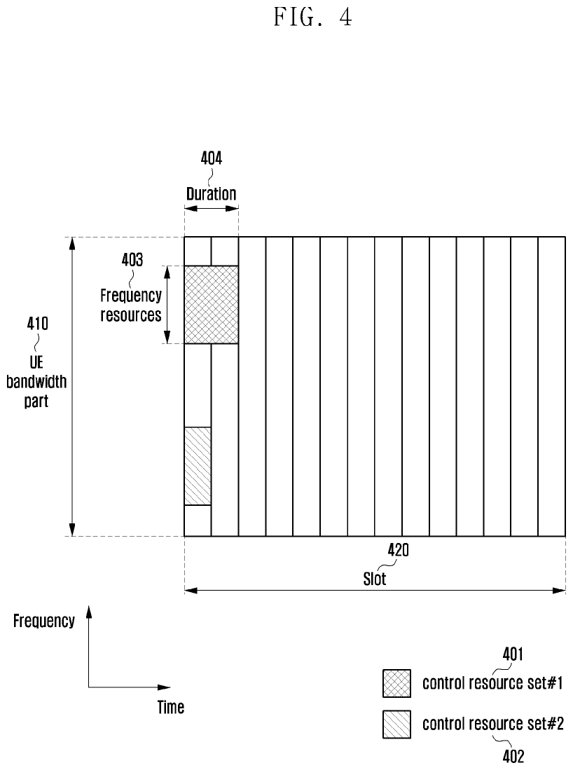

FIG. 4 illustrates an example of a control resource set in which a downlink control channel is transmitted in a 5G wireless communication system. FIG. 4 illustrates an example in which a UE bandwidth part 410 is configured in the frequency axis and two control resource sets (control resource set #1 401 and control resource set #2 402) are configured within one slot 420 in the time axis. The control resource sets 401 and 402 may be configured in specific frequency resources 403 within a total UE BWP 410 in the frequency axis. The control resource set may be configured as one or a plurality of OFDM symbols in the time axis, which may be defined as a control resource set duration 404. Referring to the example illustrated in FIG. 4, control resource set #1 201 may be configured as a control resource set duration of 2 symbols, and control resource set #2 402 may be configured as a control resource set duration of 1 symbol. The control resource set in the 5G system may be configured in the UE by the BS through higher layer signaling (for example, system information, MIB, or RRC signaling which may be interchanged with higher signaling). Configuring the control resource set in the UE may mean providing information such as a control resource set identity, a frequency location of the control resource set, and a symbol length of the control resource set. For example, the higher layer signaling may include information in [Table 5] below.

TABLE 5

```
ControlResourceSet ::=  SEQUENCE {
  -- Corresponds to L1 parameter ‘CORESET-ID’
      controlResourceSetId
      ControlResourceSetId,
        (control resource set identity)
      frequencyDomainResources  BIT  STRING
(SIZE (45)),
        (frequency axis resource allocation information)
      duration
      INTEGER (1..maxCoReSetDuration),
        (time axis resource allocation information)
      cce-REG-MappingType
      CHOICE {
        CCE-to-REG mapping scheme)
              interleaved
              SEQUENCE {
                      reg-BundleSize
              ENUMERATED {n2, n3, n6},
            REG bundle size)
                      precoderGranularity
              ENUMERATED {sameAsREG-bundle, allContiguousRBs},
                      interleaverSize
              ENUMERATED {n2, n3, n6}
                      (interleaver size)
                      shiftIndex
                      INTEGER(0..maxNrofPhysicalResourceBlocks-1)
                                                          OPTIONAL
                (interleaver shift)
            },
        nonInterleaved  NULL
        },
        tci-StatesPDCCH
        SEQUENCE(SIZE (1..maxNrofTCI-StatesPDCCH)) OF TCI-StateId
                            OPTIONAL,
          (QCL configuration information)
        tci-PresentInDCI  ENUMERATED
{enabled}
                                            OPTIONAL, -- Need S
      }
```

The configuration information of tci-StatesPDCCH (simply referred to as a transmission configuration indication (TCI) state) in [Table 5] may include information on one or a plurality of SS/PBCH block indexes or channel state information reference signal (CSI-RS) indexes having the QCL relation with a DMRS transmitted in a corresponding control resource set.

Subsequently, downlink control information (DCI) transmitted in a downlink control channel in the 5G system is described in detail.

In the 5G system, scheduling information for uplink data (or a physical uplink data channel (physical uplink shared channel (PUSCH)) or downlink data (or physical downlink data channel (physical downlink shared channel (PDSCH)) is transmitted from the BS to the UE through DCI. The UE may monitor a fallback DCI format and a non-fallback DCI format for the PUSCH or the PDSCH. The fallback DCI format may include a fixed field predefined between the BS and the UE, and the non-fallback DCI format may include a configurable field. In addition, there are various formats in DCI, and each format may indicate whether DCI is for controlling power or notifying of a slot format indicator (SFI).

The DCI may be transmitted through a PDCCH which is a physical downlink control channel via a channel coding and modulation process. A cyclic redundancy check (CRC) may be added to a DCI message payload and may be scrambled by a radio network temporary identifier (RNTI) corresponding to the identity of the UE. Depending on the purpose of the DCI message, for example, UE-specific data transmission, a power control command, a random access response, or the like, different RNTIs may be used. That is, the RNTI is not explicitly transmitted but is included in a CRC calculation process to be transmitted. If the DCI message transmitted through the PDCCH is received, the UE may identify the CRC through the allocated RNTI, and may recognize that the corresponding message is transmitted to the UE when the CRC is determined to be correct on the basis of the CRC identification result. The PDCCH is mapped to a control resource set (CORESET) configured in the UE and transmitted.

For example, DCI for scheduling a PDSCH for system information (SI) may be scrambled by an SI-RNTI. DCI for scheduling a PDSCH for a random access response (RAR) message may be scrambled by an RA-RNTI. DCI for scheduling a PDSCH for a paging message may be scrambled by a P-RNTI. DCI for notifying of a slot format indicator (SFI) may be scrambled by an SFI-RNTI. DCI for notifying of transmit power control (TPC) may be scrambled with a TPC-RNTI. DCI for scheduling a UE-specific PDSCH or PUSCH may be scrambled by a cell RNTI (C-RNTI).

DCI format 0_0 may be used for fallback DCI for scheduling a PUSCH in which case the CRC may be scrambled by a C-RNTI. DCI format 0_0 in which the CRC is scrambled by the C-RNTI may include, for example, the following information.

TABLE 6
Identifier for DCI format − [1] bit
$Frequency domain resource assignment - [ ⌈ \frac{{log}_{2} ( {N}_{R B}^{UL , BWP} + 1 )}{2} ⌉ ] bits$
Time domain resource assignment − X bits
Frequency hopping flag − 1 bit
Modulation and coding scheme − 5 bits
New data indicator − 1 bit
Redundancy version − 2 bits
HARQ process number − 4 bits
Transmission power control (TCP) command for scheduled PUSCH −
[2] bits
Uplink (UL)/supplementary UL (SUL) indicator − 0 or 1 bit

DCI format 0_1 may be used for non-fallback DCI for scheduling a PUSCH in which case the CRC may be scrambled by a C-RNTI. DCI format 0_1 in which the CRC is scrambled by the C-RNTI may include, for example, the following information.

TABLE 7

Carrier indicator—0 or 3 bits
UL/SUL indicator—0 or 1 bit
Identifier for DCI formats— [1] bit
Bandwidth part indicator—0, 1, or 2 bits
Frequency domain resource assignment
For resource allocation type 0, ┌N_{RB}^{UL,BWP}/P┐ bits
For resource allocation type 1, ┌log₂(N_{RB}^{UL,BWP} + 1)/2┐ bits
Time domain resource assignment—1, 2, 3, or 4 bits
Virtual resource block (VRB)-to-physical resource
block (PRB) mapping—0 or 1 bit,
only for resource allocation type 1.
0 bits if only resource allocation type 0 is configured;
1 bit otherwise.
Frequency hopping flag—0 or 1 bit, only for
resource allocation type 1.
0 bit if only resource allocation type 0 is configured;
1 bit otherwise.
Modulation and coding scheme—5 bits
New data indicator—1 bit
Redundancy version—2 bits
HARQ process number—4 bits
1^{st} downlink assignment index—1 or 2 bits
1 bit for semi-static HARQ-ACK codebook;
2 bits for dynamic HARQ-ACK codebook with
single HARQ-ACK codebook.
2^{nd} downlink assignment index—0 or 2 bits
2 bits for dynamic HARQ-ACK codebook
with two HARQ-ACK sub-codebooks;
0 bit otherwise.
TCP command for scheduled PUSCH—2 bits
SRS resource indicator-┌log₂ (Σₖ₌₁^{^{L}}_{^{max}}(N_{SRS}_{ₖ}))┐
or ┌log₂(N_{SRS})┐ bits
┌log₂ (Σₖ₌₁^{^{L}}_{^{max}}(N_{SRS}_{ₖ}))┐ bits for non-codebook
based PUSCH transmission;
┌log₂(N_{SRS})┐ bits for codebook based PUSCH transmission.
Precoding information and number of layers—up to 6 bits
Antenna ports—up to 5 bits
SRS request—2 bits
Channel state information (CSI) request—1, 2, 3, 4, 5, or 6 bits
Code block group (CBG) transmission
information—0, 2, 4, 6, or 8 bits
Phase tracking reference signal-demodulation
reference signal (PTRS-DMRS)
association—0 or 2 bits.
beta_offset indicator—0 or 2 bits
DMRS sequence initialization—0 or 1 bit

DCI format 1_0 may be used for fallback DCI for scheduling a PDSCH in which case the CRC may be scrambled by a C-RNTI. DCI format 1_0 in which the CRC is scrambled by the C-RNTI may include, for example, the following information.

TABLE 8

Identifier for DCI formats—[1]bit
Frequency domain resource
assignment—[┌log₂(N_{RB}^{DL,BWP} (N_{RB}^{DL,BWP} + 1)/2┐] bits
Time domain resource assignment—X bits
VRB-to-PRB mapping—1 bit
Modulation and coding scheme—5 bits
New data indicator—1 bit
Redundancy version—2 bits
HARQ process number—4 bits
Downlink assignment index—2 bits
TPC command for scheduled PUCCH—[2] bits
Physical uplink control channel (PUCCH) resource
indicator—3 bits
PDSCH-to-HARQ feedback timing indicator—[3] bits

DCI format 1_1 may be used for non-fallback DCI for scheduling a PDSCH in which case the CRC may be scrambled by a C-RNTI. DCI format 1_1 in which the CRC is scrambled by the C-RNTI may include, for example, the following information.

TABLE 9

Carrier indicator—0 or 3 bits
Identifier for DCI formats—[1] bit
Bandwidth part indicator—0, 1, or 2 bits
Frequency domain resource assignment
For resource allocation type 0, ┌N_{RB}^{DL,BWP}/P┐ bits
For resource allocation type 1,
┌log₂(N_{RB}^{DL,BWP} (N_{RB}^{DL,BWP} + 1)/2┐] bits
Time domain resource assignment—1, 2, 3, or 4 bits
VRB-to-PRB mapping—0 or 1 bit, only for
resource allocation type 1.
0 bits if only resource allocation type 0 is configured;
1 bit otherwise.
PRB bundling size indicator—0 or 1 bit
Rate matching indicator—0, 1, or 2 bits
ZP CSI-RS trigger—0, 1, or 2 bits
For transport block 1:
Modulation and coding scheme—5 bits
New data indicator—1 bit
Redundancy version—2 bits
For transport block 2:
Modulation and coding scheme—5 bits
New data indicator—1 bit
Redundancy version—2 bits
HARQ process number—4 bits
Downlink assignment index—0, 2, or 4 bits
TCP command for scheduled PUCCH—2 bits
PUCCH resource indicator—3 bits
PDSCH-to-HARQ feedback timing indicator—3 bits
Antenna ports—4, 5, or 6 bits
Transmission configuration indication—0 or 3 bits
SRS request—2 bits
CBG transmission information—0, 2, 4, 6, or 8 bits
CBG flushing out information—0 or 1 bit
DMRS sequence initialization—1 bit

For example, each piece of control information included in DCI format 1_1 that is scheduling control information (DL grant) for downlink data is described below.
Carrier indicator: indicates a carrier through which data scheduled by DCI is transmitted—0 or 3 bits.
Identifier for DCI formats: indicates a DCI format and corresponds to an indicator for identifying whether corresponding DCI is for downlink or uplink—[1] bits.
Bandwidth part indicator: indicates, if there is a change in a BWP, the change—0, 1, or 2 bits.
Frequency domain resource assignment: corresponds to resource allocation information indicating frequency domain resource allocation and indicates different resources according to whether a resource allocation type is 0 or 1.
Time domain resource assignment: corresponds to resource allocation information indicating time domain resource allocation and indicates higher layer signaling or a configuration of a predetermined PDSCH time domain resource allocation list—1, 2, 3, or 4 bits.
VRB-to-PRB mapping: indicates a mapping relation between a virtual resource block (VRB) and a physical resource block (PRB)—0 or 1 bit.
PRB bundling size indicator: indicates the size of physical resource block bundling on the basis of the assumption that the same precoding is applied—0 or 1 bit.
Rate matching indicator: indicates which rate match group is applied among rate match groups configured through a higher layer applied to a PDSCH—0, 1, or 2 bits.
ZP CSI-RS trigger: triggers a zero power channel state information reference signal—0, 1, or 2 bits.
Transport block (TB)-related configuration information: indicates a modulation and coding scheme (MCS), a new data indicator (NDI), and a redundancy version (RV) for one or two TBs.
Modulation and coding scheme (MCS): indicates a modulation scheme and a coding rate used for data transmission; That is, it may indicate a coding rate value for informing of TBS and channel coding information as well as information on QPSK, 16 QAM, 64 QAM, or 256 QAM.
New data indicator: indicates HARQ initial transmission or HARQ retransmission.
Redundancy version: indicates a redundancy version of HARQ.
HARQ process number: indicates an HARQ process number applied to a PDSCH—4 bits.
Downlink assignment index: is an index for generating a dynamic HARQ-ACK codebook when HARQ-ACK for a PDSCH is reported—0, 2, or 4 bits.
TPC command for scheduled PUCCH: indicates power control information applied to a PUCCH for reporting HARQ-ACK for a PDSCH—2 bits.
PUCCH resource indicator: is information indicating resources of a PUCCH for reporting HARQ-ACK for a PDSCH.
PDSCH-to-HARQ_feedback timing indicator: is configuration information on a slot in which a PUCCH for reporting HARQ-ACK for a PDSCH is transmitted—3 bits.
Antenna ports: are information indicating a PDSCH DMRS antenna port and a DMRS CDM group in which no PDSCH is transmitted—4, 5, or 6 bits.
Transmission configuration indication: is information indicating information related to a beam of a PDSCH—0 or 3 bits.
SRS request: is information making a request for SRS transmission—2 bits.
CBG transmission information: is information indicating a code block group (CBG) to which data transmitted through a PDSCH belongs when code block group-based retransmission is configured—0, 2, 4, 6, or 8 bits.
CBG flushing out information: is information indicating whether a code block group previously received by the UE can be used for HARQ combining—0 or 1 bit.
DMRS sequence initialization: indicates a DMRS sequence initialization parameter—1 bit.

Hereinafter, a method of allocating time domain resources for a data channel in a 5G communication system is described.

The BS may configure a table for time domain resource allocation information for a downlink data channel (PDSCH) and an uplink data channel (PUSCH) in the UE through higher-layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. The time domain resource allocation information may include, for example, PDCCH-to-PDSCH slot timing (corresponding to a time interval in units of slots between a time point at which a PDCCH is received and a time point at which a PDSCH scheduled by the received PDCCH is transmitted, and indicated by K0) or PDCCH-to-PUSCH slot timing (corresponding to a time interval in units of slots between a time point at which a PDCCH is received and a time point at which a PUSCH scheduled by the received PDCCH is transmitted, and indicated by K2), information on a location and a length of a start symbol in which a PDSCH or a PUSCH is scheduled within the slot, a mapping type of a PDSCH or a PUSCH, and the like. For example, the BS may inform the UE of information in [Table 10] and [Table 11] below.

TABLE 10

```
PDSCH-TimeDomainResourceAllocationList information element
PDSCH-TimeDomainResourceAllocationList ::=  SEQUENCE (SIZE(1..maxNrofDL-
Allocations)) OF PDSCH-TimeDomainResourceAllocation
PDSCH-TimeDomainResourceAllocation ::=  SEQUENCE {
    k0  INTEGER(0..32)
OPTIONAL,  -- Need S
    (PDCCH-to-PDSCH timing, slot unit)
mappingType  ENUMERATED {typeA, typeB},
    PDSCH mapping type)
startSymbolAndLength INTEGER (0..127)
(start symbol and length of PDSCH)
}
```

TABLE 11

```
PUSCH-TimeDomainResourceAllocation information element
PUSCH-TimeDomainResourceAllocationList ::=  SEQUENCE
(SIZE(1..maxNrofUL-Allocations)) OF PUSCH-TimeDomainResourceAllocation
PUSCH-TimeDomainResourceAllocation ::=  SEQUENCE {
    k2  INTEGER(0..32)
OPTIONAL,  -- Need S
    (PDCCH-to-PUSCH timing, slot unit)
    mappingType  ENUMERATED {typeA,
typeB},
    (PUSCH mapping type)
    startSymbolAndLength  INTEGER (0..127)
    (start symbol and length of PUSCH)
}
```

The BS may inform the UE of one of the entries in the table for the time domain resource allocation information through L1 signaling (for example, DCI) (for example, indicated through a ‘time domain resource allocation field within DCI). The UE may acquire time domain resource allocation information for a PDSCH or a PUSCH on the basis of the DCI received from the BS.

In the case of data transmission through the PDSCH or the PUSCH, time domain resource assignment may be delivered by information on a slot in which the PDSCH/PUSCH is transmitted, a start symbol location S in the corresponding slot, and the number L of symbols to which the PDSCH/PUSCH is mapped. S may be a relative location from start of the slot, L may be the number of successive symbols, and S and L may be determined on the basis of a start and length indicator value (SLIV) defined as shown in [Equation 1] below.

$$if ( L - 1 ) \leq 7 then \\ SLIV = 14 \cdot ( L - 1 ) + S else \\ SLIV = 14 \cdot ( 14 - L + 1 ) + ( 14 - 1 - S ) where \\ 0 < L \leq 14 - S . \qquad [ Equation 1 ]$$

In the NR system, the UE may receive a configuration of information on an SLIV, a PDSCH/PUSCH mapping type, and a slot in which a PDSCH/PUSCH is transmitted in one row through RRC configuration (for example, the information may be configured in a table form). Thereafter, in the time domain resource assignment of the DCI, the BS may transmit information on the SLIV, the PDSCH/PUSCH mapping type, and the slot in which the PDSCH/PUSCH is transmitted by indicating an index value in the configured table.

In the NR system, a type A and a type B is defined as the PDSCH mapping type. In the PDSCH mapping type A, a first symbol of the DMRS symbols is located in a second or third OFDM symbol of the slot. In the PDSCH mapping type B, a first symbol of the DMRS symbols is located in a first OFDM symbol in time domain resources allocated through PUSCH transmission.

Downlink data may be transmitted through a PDSCH which is a physical channel for downlink data transmission. The PDSCH may be transmitted after the control channel transmission interval, and scheduling information such as the detailed mapping location in the frequency domain and the modulation scheme is determined on the basis of the DCI transmitted through the PDCCH.

Through the MCS in the control information included in the DCI, the BS notifies the UE of a modulation scheme applied to the PDSCH to be transmitted and the size of data (transport block size (TBS)) to be transmitted. According to an embodiment, the MCS may include 5 bits or bits larger or less than 5 bits. The TBS corresponds to the size before channel coding for error correction is applied to the data (transport block (TB)) to be transmitted by the BS.

In the disclosure, the transport block (TB) may include a medium access control (MAC) header, a MAC control element, one or more MAC service data units (SDUs), and padding bits. Alternatively, the TB may indicate a unit of data delivered from a MAC layer to a physical layer or a MAC protocol data unit (PDU).

Modulation schemes supported by the NR system are quadrature phase shift keying (QPSK), 16 quadrature amplitude modulation (QAM), 64 QAM, and 256 QAM, and modulation orders (Qₘ) thereof correspond to 2, 4, 6, and 8, respectively. That is, 2 bits may be transmitted per symbol in the QPSK modulation, 4 bits may be transmitted per symbol in the 16 QAM modulation, 6 bits may be transmitted per symbol in the 64 QAM modulation, and 8 bits may be transmitted per symbol in the 256 QAM modulation.

Terms “physical channel” and “signal” in the NR system may be used to describe the method and the apparatus provided by embodiments. However, the disclosure may be applied to a wireless communication system rather than the NR system.

Hereinafter, embodiments of the disclosure will be described in detail with reference to the accompanying drawings. Further, in the description of the disclosure, if it is determined that a detailed description of a relevant function or element unnecessarily makes the subject of the disclosure unclear, the detailed description is omitted. The terms which will be used below are terms defined in consideration of the functions in the disclosure, and may differ according to users, intentions of users, or customs. Therefore, the definitions of the terms should be made based on the contents throughout the specification.

In the disclosure, “downlink (DL)” refers to a wireless transmission path of a signal that the BS transmits to the UE, and “uplink (UL)” refers to a wireless transmission path of a signal that the UE transmits to the BS.

Hereinafter, although the NR system is described as an example in embodiments of the disclosure, the embodiments of the disclosure may also be applied to other communication system having a similar technical background or channel form. Further, embodiments of the disclosure may be applied to other communication system through some modifications without departing the scope of the disclosure on the basis of a determination of those skilled in the art.

In the disclosure, the conventional terms “physical channel” and “signal” may be interchangeably used with “data” or “control signal.” For example, a PDSCH is a physical channel for transmitting data, but may refer to data in the disclosure.

Hereinafter, in the disclosure, higher-layer signaling may be a method of transmitting a signal from the BS to the UE through a downlink data channel of a physical layer or from the UE to the BS through an uplink data channel of a physical layer, and may also be referred to as RRC signaling or a MAC control element (CE).

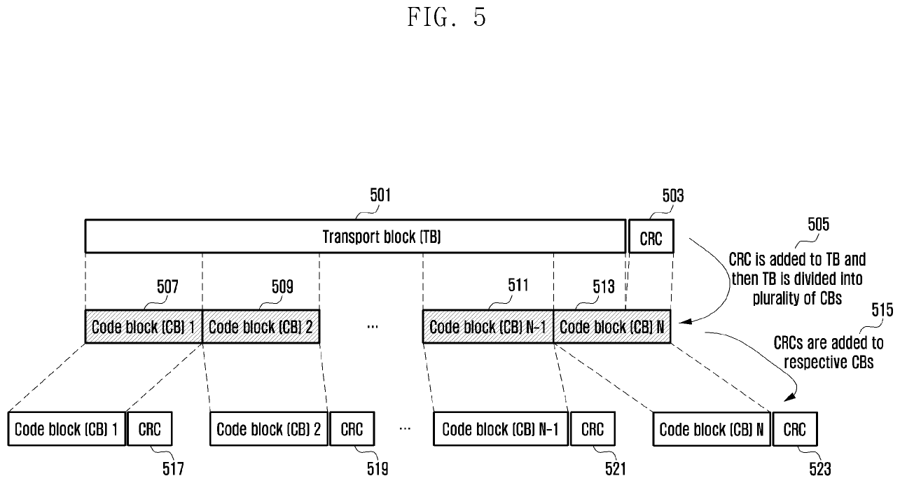

FIG. 5 illustrates an example of a process in which one transport block is segmented into a plurality of code blocks and a CRC is added.

Referring to FIG. 5, a CRC 503 may be added to the last or first part of one transport block (TB) 501 to be transmitted in the uplink or downlink. The CRC 503 may have 16 bits, 25 bits, a prefixed number of bits, or a variable number of bits according to a channel condition, and may be used to determine whether channel coding is successful. A block obtained by adding the CRC 503 to the TB 501 may be segmented into a plurality of code blocks (CBs) 507, 509, 511, and 513 as indicated by reference numeral 505. The segmented code blocks may have a predetermined maximum size in which case the last code block 513 may have the size smaller than the sizes of the other blocks 507, 509, and 511. However, this is only an example, and the sizes of the last code block 513 and the other code blocks 507, 509, and 511 may become the same through insertion of 0, a random value, or 1 into the last code block 513 according to another embodiment.

Further, CRCs 517, 519, 521, and 523 may be added to the code blocks 507, 509, 511, and 513, respectively. The CRC may have 16 bits, 24 bits, a prefixed number of bits, or a variable number of bits, and may be used to determine whether channel coding is successful.

The TB 501 and a cyclic generator polynomial may be used to generate the CRC 503, and the cyclic generator polynomial may be defined through various methods. For example, when it is assumed that a cyclic generator polynomial for a 24-bit CRC is gCRC24A(D)=D24+D23+D18+D17+D14+D11+D10+D7+D6+D5+D4+D3+D+1 and L=24, CRC p₀, p₁, p₂, p₃, . . . , p_{L-1} that makes the remainder, obtained by dividing a₀D^{A+23}+a₁D^{A+22}+ . . . +a_{A-1}D²⁴+p₀D²³+p₁D²²+ . . . p₂₂D¹+p₂₃ by gCRC24A(D), 0 may be determined for TB data a₀, a₁, a₂, a₃, . . . , a_{A-1}. In the above-described example, it is assumed that the CRC length L is 24 as an example, the CRC length L may be determined as various lengths such as 12, 16, 24, 32, 40, 48, 64, and the like.

After the CRC is added to the TB through the process, TB+CRC may be segmented into N CBs 507, 509, 511, and 513. The CRCs 517, 519, 521, and 523 may be added to the segmented CBs 507, 509, 511, and 513 as indicated by reference numeral 515. The CRC added to the CB may be a different length from that when the CRC added to the TB is generated, or another cyclic generator polynomial may be used to generate the CRC. Further, the CRC 503 added to the TB and the CRCs 517, 519, 521, and 523 added to the code blocks may be omitted according to the type of a channel code to be applied to the code blocks. For example, when an LDPC code rather than a turbo code is applied to the code blocks, the CRCs 517, 519, 521, and 523 to be added to the code blocks may be omitted.

However, even when the LDPC code is applied, the CRCs 517, 519, 521, and 523 may be added to the code blocks. Further, the CRC may be added or omitted when a polar code is used.

As illustrated in FIG. 5, in the TB to be transmitted, a maximum length of one code block may be determined according to the type of applied channel coding, and the TB and the CRC added to the TB may be segmented into code blocks according to the maximum length of the code block.

In the conventional LTE system, CRCs for CB may be added to segmented CBs, data bits of the CBs and the CRCs are encoded by a channel code to determine coded bits, and the number of rate-matching bits is determined as pre-appointed for the coded bits.

In the NR system, the TB size (TBS) may be calculated via the following steps.

Step 1: N′_{RE} that is the number of REs allocated for PDSCH mapping in one PRB within allocated resources is calculated.

N′_{RE} may be calculated as N_{sc}^{RB}·N_{symb}^{sh}−N_{DMRS}^{PRB}−Nₒₕ^{RB} is 12, and N_{symb}^{sh} may indicate the number of OFDM symbols allocated to the PDSCH. N_{DMRS}^{PRB} is the number of REs within one PRB occupied by DMRSs in the same CDM group. N is the number of REs occupied by overhead within one PRB configured through higher-layer signaling, and may be configured as one of 0, 6, 12, and 18. Thereafter, the total number N_{RE} of REs allocated to the PDSCH may be calculated. N_{RE} is calculated as min(156,N′_{RE})·n_{PRB}, and n_{PRB} denotes the number of PRBs allocated to the UE.

Step 2: N_{info} that is the number of temporary information bits may be calculated as N_{RE}*R*Qₘ*v. R is a code rate, Qm is a modulation order and information on the value may be transmitted using an MCS bit field of DCI and a pre-appointed table. Further, vi is the number of allocated layers. If N_{info}≤3824, the TBS may be calculated through step 3 below. In other cases, the TBS may be calculated through step 4.

Step 3: N′_{info} may be calculated through equations of

$${N}_{info}^{′} = max ( 24 , {2}^{n} * ⌊ \frac{{N}_{info}}{{2}^{n}} ⌋ )$$

and n=max(3,└log₂(N_{info})┘−6). A value closest to N′_{info} may be determined as the TBS among values which are not smaller than N′_{info} in [Table 12A] below.

TABLE 12A

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

Step 4: N′_{info} may be calculated through equations of

$${N}_{info}^{′} = max ( 3840 , {2}^{n} \times round ( \frac{{N}_{info} - 24}{{2}^{n}} ) )$$

and n=└log₂(N_{info}−24)┘−5. The TBS may be calculated through N′_{info} and [pseudo-code 1] below. C corresponds to the number of code blocks included in one TB. Table 2B shows the pseudo-code.

TABLE 12B

```
[Pseudo-code 1 starts]
if R ≤ 1/4
  $TBS = 8 \cdot C \cdot ⌈ \frac{{N}_{info}^{′} + 24}{8 \cdot C} ⌉ - 24 , where C = ⌈ \frac{{N}_{info}^{′} + 24}{3816} ⌉$
else
  if N_{info}^{′} > 8424
    $TBS = 8 \cdot C \cdot ⌈ \frac{{N}_{info}^{′} + 24}{8 \cdot C} ⌉ - 24 , where C = ⌈ \frac{{N}_{info}^{′} + 24}{8424} ⌉$
  else
      $TBS = 8 \cdot ⌈ \frac{{N}_{info}^{′} + 24}{8} ⌉ - 24$
  end if
  end if
[Pseudo-code 1 ends]
```

In the NR system, when one CB is input into an LDPC encoder, parity bits may be added and output. At this time, an amount of parity bits may vary depending on an LDCP base graph. A method of sending all parity bits generated by LDPC coding for a specific input may be full buffer rate matching (FBRM), and a method of limiting the number of parity bits which can be transmitted may be limited buffer rate matching (LBRM). When resources are allocated for data transmission, a circular buffer may be made by the LDPC encoder output, bits of the made buffer may be transmitted repeatedly by the number of allocated resources, and the length of the circular buffer may be Neb.

When the number of all parity bits generated by LDPC coding is N, N_{cb}=N in the FBRM method. In the LBRM method, N_{cb} is min(N,N_{ref}), N_{ref} is

$$⌊ \frac{{TBS}_{LBRM}}{C \cdot {R}_{LBRM}} ⌋ ,$$

and R_{LBRM} may be determined as ⅔. In order to calculate TBS_{LBRM}, the aforementioned method of calculating the TBS is used and the maximum number of layers and a maximum modulation order supported by the UE in the corresponding cell are assumed. The maximum modulation order Qₘ is assumed as 8 when it is configured to use an MCS table supporting 256 QAM for at least one BWP in the corresponding cell and as 6 (64 QAM) when it is not configured to use the MCS table, the code rate is assumed as 948/1024 that is a maximum code rate, N_{RE} is assumed as 156·n_{PRB}, and n_{PRB} is assumed as n_{PRB,LBRM}. n_{PRB,LBRM} may be given as shown in [Table 13] below.

TABLE 13

| Maximum number of PRBs across all configured | |
|---|---|
| DL BWPs and UL BWPs of a carrier for DL- | |
| SCH and UL-SCH, respectively | n_{PRB,LBRM} |
| Less than 33 | 32 |
| 33 to 66 | 66 |
| 67 to 107 | 107 |
| 108 to 135 | 135 |
| 136 to 162 | 162 |
| 163 to 217 | 217 |
| Larger than 217 | 273 |

A maximum data rate supported by the UE in the NR system may be determined through [Equation 2] below.

$$data rate ( in Mbps ) = {10}^{- 6} \cdot {\sum }_{j = 1}^{l} ( {v}_{Layers}^{( j )} \cdot {Q}_{m}^{( j )} \cdot {f}^{( j )} \cdot {R}_{max} \cdot \frac{{N}_{PRB}^{BW ( j ) μ} \cdot 12}{{T}_{s}^{μ}} \cdot ( 1 - {OH}^{( j )} ) ) . \qquad [ Equation 2 ]$$

In [Equation 2], J is the number of carriers grouped by carrier aggregation, Rₘₐₓ=948/1024, v_{layers}^{(j)} is the maximum number of layers, Qₘ^{(j)} is a maximum modulation order, f^{(j)} is a scaling index, and μ is subcarrier spacing. For f^{(j)}, one of 1, 0.8, 0.75, and 0.4 may be reported by the UE, and μ may be given as shown in [Table 14] below.

TABLE 14

| μ | Δƒ = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

T₂^{μ} is an average OFDM symbol length, Tₛ^{μ} may be calculated as

$$\frac{{10}^{-} \text{?}}{14 \cdot {2}^{μ}} , \\ \text{?} \text{indicates text missing or illegible when filed}$$

and N_{PRB}^{BW(j),μ} is the maximum number of RBs in BW(j). OH^{(j)} is an overhead value and may have 0.14 in the downlink of FR1 (band equal to or lower than 6 GHz) and 0.18 in the uplink and 0.08 in the downlink of FR2 (band higher than 6 GHz) and 0.10 in the uplink. A maximum data rate in the downlink in a cell having a frequency bandwidth of 100 MHz with subcarrier spacing of 30 kHz may be calculated through [Equation 2] as shown in [Table 15] below.

TABLE 15

| ƒ^{(j)} | v_{layers}^{(f)} | Qₘ^{(j)} | Rmax | N_{PRB}^{(BW(j),μ} | Tₛ^{μ} | OH^{(j)} | data rate |
|---|---|---|---|---|---|---|---|
| 1 | 4 | 8 | 0.92578125 | 273 | 3.57143E−05 | 0.14 | 2337.0 |
| 0.8 | 4 | 8 | 0.92578125 | 273 | 3.57143E−05 | 0.14 | 1869.6 |
| 0.75 | 4 | 8 | 0.92578125 | 273 | 3.57143E−05 | 0.14 | 1752.8 |
| 0.4 | 4 | 8 | 0.92578125 | 273 | 3.57143E−05 | 0.14 | 934.8 |

On the other hand, a real data rate which can be measured by the UE in real data transmission may be a value obtained by dividing an amount of data by a data transmission time. This may be a value obtained by dividing the TBS by the TTI length in 1-TB transmission and dividing a sum of TBSs by the TTI length in 2-TB transmission. For example, as assumed in [Table 15], a maximum real data rate in the downlink in a cell having a frequency bandwidth of 100 MHz with subcarrier spacing of 30 kHz may be determined according to the number of allocated PDSCH symbols as shown in [Table 16] below.

TABLE 16

| | | | | | | | | | TTI | |
|---|---|---|---|---|---|---|---|---|---|---|
| | | | | | | | | | length | data rate |
| N_{symb}^{sh} | N_{DMRS}^{PRB} | N′_{RE} | N_{RE} | N_{info} | n | N′_{info} | C | TBS | (ms) | (Mbps) |
| 3 | 8 | 28 | 7644 | 226453.5 | 12 | 225,280 | 27 | 225,480 | 0.107143 | 2,104.48 |
| 4 | 8 | 40 | 10920 | 323505.0 | 13 | 319,448 | 38 | 319,784 | 0.142857 | 2,238.49 |
| 5 | 8 | 52 | 14196 | 420556.5 | 13 | 417,792 | 50 | 417,976 | 0.178571 | 2,340.67 |
| 6 | 8 | 64 | 17472 | 517608.0 | 13 | 516,096 | 62 | 516,312 | 0.214286 | 2,409.46 |
| 7 | 8 | 76 | 20748 | 614659.5 | 14 | 622,592 | 74 | 622,760 | 0.250000 | 2,491.04 |
| 8 | 8 | 88 | 24024 | 711711.0 | 14 | 704,512 | 84 | 704,904 | 0.285714 | 2,467.16 |
| 9 | 8 | 100 | 27300 | 808762.5 | 14 | 802,816 | 96 | 803,304 | 0.321429 | 2,499.17 |
| 10 | 8 | 112 | 30576 | 905814.0 | 14 | 901,120 | 107 | 901,344 | 0.357143 | 2,523.76 |
| 11 | 8 | 124 | 33852 | 1002865.5 | 14 | 999,424 | 119 | 999,576 | 0.392857 | 2,544.38 |
| 12 | 8 | 136 | 37128 | 1099917.0 | 15 | 1,114,112 | 133 | 1,115,048 | 0.428571 | 2,601.78 |
| 13 | 8 | 148 | 40404 | 1196968.5 | 15 | 1,212,416 | 144 | 1,213,032 | 0.464286 | 2,612.68 |
| 14 | 8 | 160 | 43680 | 1294020.0 | 15 | 1,277,952 | 152 | 1,277,992 | 0.500000 | 2,555.98 |

The maximum data rate supported by the UE may be identified through [Table 15], and a real data rate according to the allocated TBS may be identified through [Table 16]. At this time, the real data rate may be larger than the maximum data rate according to scheduling information.

In the wireless communication system, particularly, in the new radio (NR) system, a data rate which can be supported by the UE may be appointed between the BS and the UE. This may be calculated using a maximum frequency band supported by the UE, a maximum modulation order, the maximum number of layers, and the like. However, the calculated data rate may be different from a value calculated on the basis of the size of a transport block (TB) (transport block size (TBS) used for real data transmission and a transmission time interval (TTI) length.

Accordingly, the UE may receive a TBS larger than a value corresponding to the data rate supported by the UE, and thus there may be limitation on the TBS which can be scheduled according to the data rate supported by the UE in order to prevent the problem.

Since the UE is generally spaced apart from the BS, a signal transmitted by the UE is received by the BS after a propagation delay. The propagation delay is a value obtained by dividing a path of propagation from the UE to the BS by the velocity of light, and may be a value obtained by dividing the distance from the UE to the BS by the velocity of light. In an embodiment, when the UE is spaced apart from the BS by 100 km, a signal transmitted by the UE is received by the BS after about 0.34 msec. Inversely, a signal transmitted by the BS is received by the UE after about 0.34 msec. As described above, a time at which the signal transmitted by the UE arrives at the BS may be different according to the distance between the UE and the BS. Accordingly, when a plurality of UEs existing in different locations transmit signals at the same time, times at which the signals arrive at the BS may be all different. In order to make the signals transmitted by the plurality of UEs arrive at the BS at the same time by solving the problem, times at which uplink signals are transmitted may be determined to be different according to locations of the UEs. In the 5G, NR, and LTE systems, this is called timing advance.

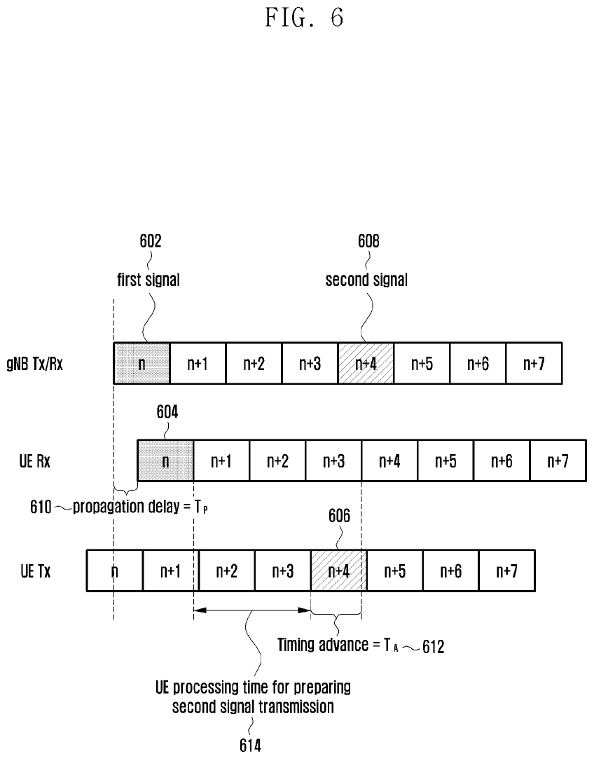

FIG. 6 illustrates a processing time of the UE according to timing advance when the UE receives a first signal and transmits a second signal in response thereto in the 5G or NR system according to various embodiments of the present disclosure.

Hereinafter, a processing time of the UE according to timing advance is described in detail. When the BS transmits an uplink scheduling grant (UL grant) or a downlink control signal and data (DL grant and DL data) to the UE in slot n 602, the UE may receive the uplink scheduling grant or the downlink control signal and the data in slot n 604. At this time, the UE may receive a signal later than a time at which the BS transmits the signal by a propagation delay (Tₚ) 610. In the embodiment, when the UE receives the first signal in slot n 604, the UE transmits the corresponding second signal in slot n+4 606. When the UE transmits a signal to the BS, the UE may transmit HARQ ACK/NACK for uplink data or downlink data at timing 606 earlier than slot n+4, in which the UE receives the signal, by timing advance (TA) 612 in order to make the signal arrive at the BS at a specific time. Accordingly, in the embodiment, a time for which the UE prepares receiving the uplink scheduling grant, transmitting uplink data or receiving downlink data, and transmitting HARQ ACK or NACK may be a time obtained by subtracting TA from a time corresponding to 3 slots as indicated by reference numeral 614.

In order to determine the timing, the BS may calculate an absolute value of TA of the corresponding UE. When the UE initially accesses, the BS may calculate the absolute value of TA while adding a change in the TA transmitted through higher-layer signaling to the TA initially transmitted to the UE in a random access step or subtracting the change in the TA from the initially transmitted TA. In the disclosure, the absolute value of the TA may be a value obtained by subtracting a start time of an nth TTI which the UE receives from a start time of an nth TTI which the UE transmits.

Meanwhile, one of the important references of the performance of a cellular wireless communication system is packet data latency. To this end, signals are transmitted and received in units of subframes having a transmission time interval (TTI) of 1 ms in the LTE system. In the LTE system operating as described above, the UE (short-TTI UE) having a TTI shorter than 1 ms may be supported. Meanwhile, in the 5G or NR system, the TTI may be shorter than 1 ms. The short-TTI UE is suitable for services such as a voice over LTE (VoLTE) in which latency is important, and remote control. Further, the short-TTI UE may be a means to realize cellular-based mission-critical Internet of things (IoT).

In the 5G or NR system, when the BS transmits a PDSCH including downlink data, DCI for scheduling the PDSCH indicates a K1 value that is a value corresponding to information on timing at which the UE transmits HARQ-ACK information of the PDSCH. When transmission of HARQ-ACK information including timing advance earlier than the symbol L1 is not indicated, the UE may transmit the HARQ-ACK information to the BS. That is, HARQ-ACK information may be transmitted from the UE to the BS at a time point that is the same as or later than the symbol L1, including timing advance. When transmission of HARQ-ACK information including timing advance earlier than the symbol L1 is indicated, the HARQ-ACK information may not be HARQ-ACK information effective for HARQ-ACK transmission from the UE to the BS.

The symbol L1 may be a first symbol at which cyclic prefix (CP) starts after T_{proc,i} from the last time point of the PDSCH. T_{proc,1} may be calculated as shown in [Equation 3] below.

T_{proc,3}=((N₁+d_{1,1}+d_{1,2})(2048+144)·κ2^{-μ})·T_{C}.[Equation 3]

In [Equation 3] above, N₁, d_{1,1}, d_{1,2}, κ, μ, and TC may be defined as follows.
d_{1,1}=0 when HARQ-ACK information is transmitted through a PUCCH (uplink control channel) and, d_{1,1}=1 when HARQ-ACK information is transmitted through a PUSCH (uplink shared channel, data channel).
When the UE receives a configuration of a plurality of activated component carriers or carriers, a maximum timing difference between carriers may be reflected in second signal transmission.
In the case of a PDSCH mapping type A, that is, in the case in which a first DMRS symbol location is a third or fourth symbol in the slot, d_{1,2}=7−i when a location index i of the last symbol of the PDSCH is smaller than 7.
In the case of a PDSCH mapping type B, that is, in the case in which the first DMRS symbol location is a first symbol of the PDSCH, d_{1,2}=3 when the length of the PDSCH is 4 symbols, d_{1,2}=3+d when the length of the PDSCH is 2 symbols, and d is the number of symbols in which the PDSCH overlaps a PDCCH including a control signal for scheduling the corresponding PDSCH.
N₁ is defined according to as shown in [Table 17] below. μ=0, 1, 2, 3 corresponds to subcarrier spacing 15 kHz, 30 kHz, 60 kHz, and 120 kHz.

TABLE 17

| | PDSCH decoding time N₁ [symbols] | |
|---|---|---|
| | No additional PDSCH DM- | Additional PDSCH DM-RS |
| μ | RS configured | configured |
| 0 | 8 | 13 |
| 1 | 10 | 13 |
| 2 | 17 | 20 |
| 3 | 20 | 24 |

N₁ provided by [Table 17] above may be different according to UE capability: T_{c}==1/(Δfₘₐₓ·N_{f}), Δfₘₐₓ=480·10³ Hz, N_{f}=4096, κ=Tₛ/T_{c}=64, Tₛ=1/(Δf_{ref}·N_{f,ref}), Δf_{ref}=15·10³ Hz, N_{f,ref}=2048

In the 5G or NR system, when the BS transmits control information including the uplink scheduling grant, a K2 value corresponding to information on timing at which the UE transmits uplink data or the PUSCH may be indicated.

When transmission of the PUSCH including timing advance earlier than the symbol L2 is not indicated, the UE may transmit the PUSCH to the BS. That is, the PUSCH may be transmitted from the UE to the BS at a time point that is the same as or later than the symbol L2, including timing advance. When transmission of the PUSCH including timing advance earlier than the symbol L2 is indicated, the UE may ignore uplink scheduling grant control information from the BS.

The symbol L2 may be a first symbol at which a CP of a PUSCH symbol which may be transmitted after T_{proc,2} from the last time point of the PDCCH including the scheduling grant starts. T_{proc,2} may be calculated as shown in [Equation 4] below:

T_{proc,2}=((N₂+d_{2,1})(2048±144)·κ2^{-μ})·T_{C}. [Equation 4]

In [Equation 4] above, N₂, d_{2,1}, κ, μ, and Tc may be defined as follows.
d_{2,1}=0 when a first symbol of the symbols to which the PUSCH is allocated includes only a DMRS, and otherwise, d_{2,1}=1.
When the UE receives a configuration of a plurality of activated component carriers or carriers, a maximum timing difference between carriers may be reflected in second signal transmission.
N₂ is defined according to μ as shown in [Table 18] below. μ=0, 1, 2, 3 means subcarrier spacing 15 kHz, 30 kHz, 60 kHz, and 120 kHz.

TABLE 18

| μ | PUSCH preparation time N₂ [symbols] |
|---|---|
| 0 | 10 |
| 1 | 12 |
| 2 | 23 |
| 3 | 36 |

N2 provided by [Table 18] above may be different according to UE capability: T_{c}=1/(Δfₘₐₓ·N_{f}), Δfₘₐₓ=480·10³ Hz, N_{f}=4096, κ=Tₛ/T_{c}=64, Tₛ=1/(Δf_{ref}·N_{f,ref}), Δf_{ref}=15·10³ Hz, N_{f,ref}=2048

Meanwhile, the 5G or NR system may configure a frequency BWP within one carrier and designate transmission and reception by a specific UE within the BWP. This is to reduce power consumption of the UE. The BS may configure a plurality of BWPs and change activated BWPs in control information. A time used by the UE to change the BWPs may be defined as shown in [Table 19] below.

TABLE 19

| Frequency | | Type 1 | Type 2 |
|---|---|---|---|
| range | Scenario | delay (μs) | delay (μs) |
| 1 | 1 | 600 | 2000 |
| | 2 | 600 | 2000 |
| | 3 | 600 | 2000 |
| | 4 | 400 | 950 |
| 2 | 1 | 600 | 2000 |
| | 2 | 600 | 2000 |
| | 3 | 600 | 2000 |
| | 4 | 400 | 950 |

In [Table 19], frequency range 1 is a frequency band equal to lower than 6 GHz, and frequency range 2 is a frequency band higher than or equal to 6 GHz. In the above embodiment, type 1 and type 2 may be determined according to UE capability. In the above embodiment, scenarios 1, 2, 3, and 4 are shown in [Table 20] below.

TABLE 20

| | Chance in center | Unchanged in center |
|---|---|---|
| | frequency | frequency |
| Change in frequency | Scenario 3 | Scenario 2 |
| bandwidth | | |
| Unchanged in frequency | Scenario 1 | Scenario 4 when subcarrier |
| bandwidth | | spacing is changed |

FIG. 7 illustrates an example in which data (for example, TBs) are scheduled and transmitted according to a slot, an HARQ-ACK feedback for the corresponding data is received, and retransmission is performed according to the feedback. In FIG. 7, TB #1 700 is initially transmitted in slot #0 702, and an ACK/NACK feedback 704 therefor is transmitted in slot #4 706. If initial transmission of TB #1 fails and NACK is received, retransmission 710 of TB #11 is performed in slot #8 708. A time point at which the ACK/NACK feedback is transmitted and a time point at which retransmission is performed may be predetermined or may be determined according to control information or/and a value indicated by higher-layer signaling.

FIG. 7 illustrates an example in TB #1 to TB #8 are sequentially scheduled and transmitted according to slots from slot no. 0. This may mean transmission of TB #1 to TB #8 to which HARQ process IDs 0 to 7 are assigned. If the number of HARQ process IDs which can be used by the BS and the UE is only 4, transmission for 8 different TBs may not be successively performed.

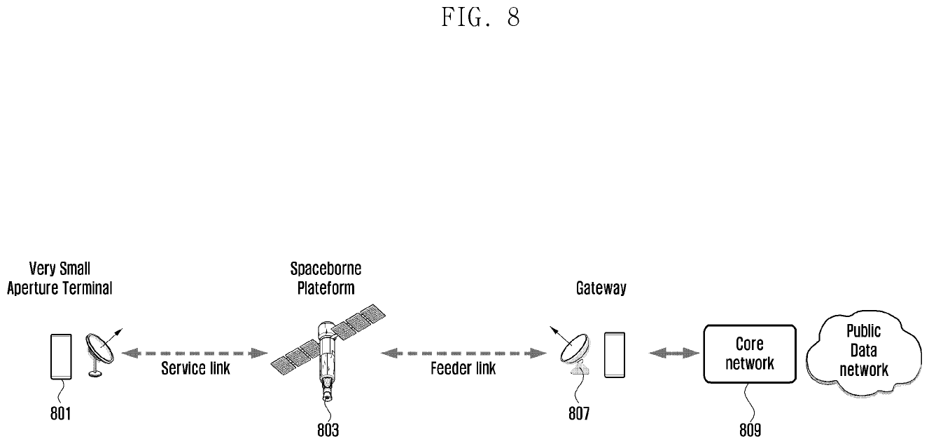

FIG. 8 illustrates an example of a communication system using a satellite. For example, when a UE 801 transmits a signal to a satellite 803, the satellite 803 may transmit the signal to a BS 805, and the BS 805 may process the received signal and transmit the signal including a demand of the following operation therefor to the UE 801 through the satellite 803 again. The distance between the UE 801 and the satellite 803 is long and the distance between the satellite 803 and the BS 805 is also long, and thus a time spent for data transmission/reception from the UE 801 to the BS 805 may become longer.

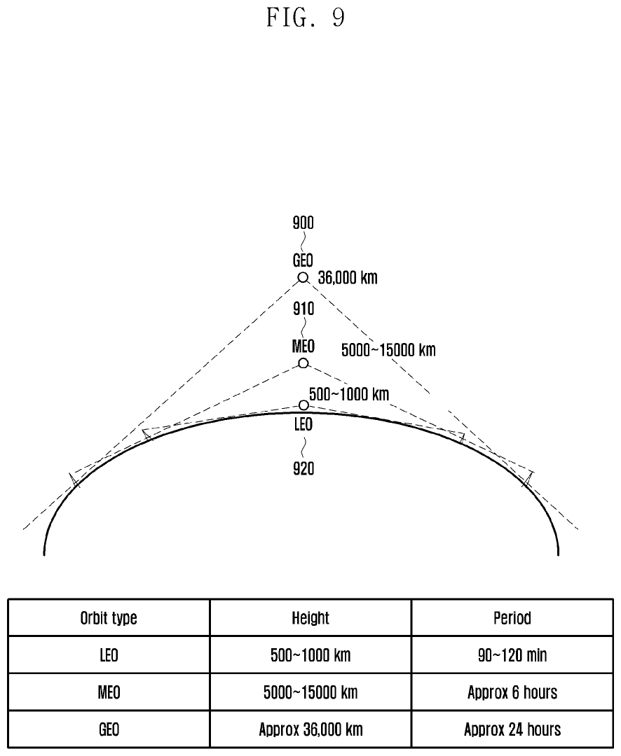

FIG. 9 illustrates the revolution period of a communication satellite around the earth according to an altitude or height of the satellite. Satellites for communication may be divided into a low earth orbit (LEO), a meddle earth orbit (MEO), a geostationary earth orbit (GEO), and the like depending on the satellite orbit. In general, the GEO 900 refers to a satellite having an altitude of 36000 km, the MEO 910 refers to a satellite having an altitude from 5000 to 15000 km, and the LEO refers to a satellite having an altitude from 500 to 1000 km. The revolution period around the earth varies depending on the altitude, and the GEO 900 has the revolution period around the earth of about 24 hours, the MEO 910 has about 6 hours, and the LEO 920 has about 90 to 120 minutes. The low orbit (˜2,000 km) satellite has a shorter propagation delay time (understood as a time spent until a signal output from a transmitter arrives at a receiver) and lower loss with a relatively low altitude than the geostationary orbit (36,000 km) satellite. Satellites other than the GEO satellite may be referred to as non-geostationary orbits (NGSOs).

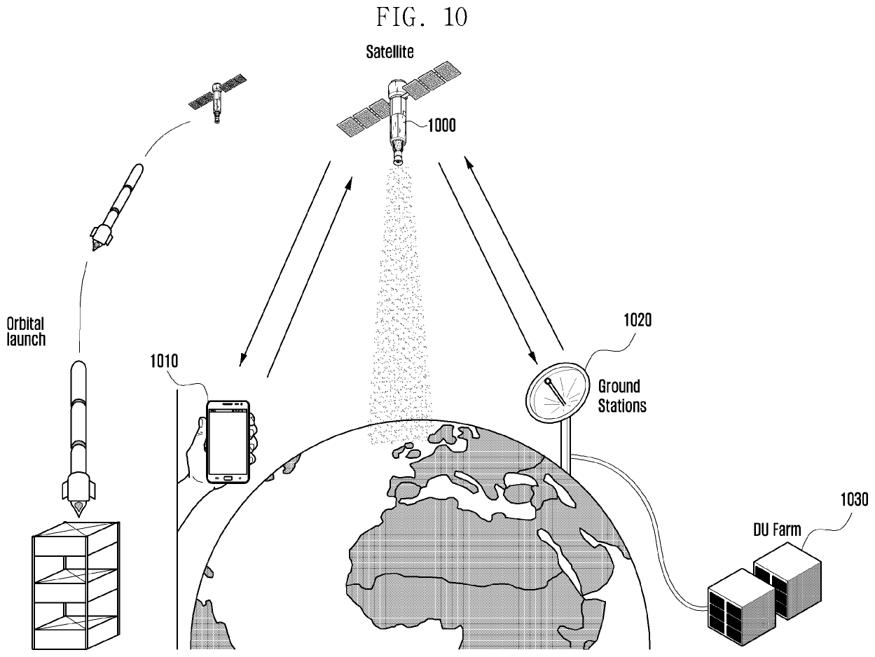

FIG. 10 illustrates the concept of direct communication between a satellite and a UE. A satellite 1000 located at a place higher than or equal to altitude 100 km by a rocket transmits and receives a signal to and from the UE 1010 on the ground and also transmits and receives a signal to and from a ground station 1020 connected to a BS on the ground (DU farms) 1030.

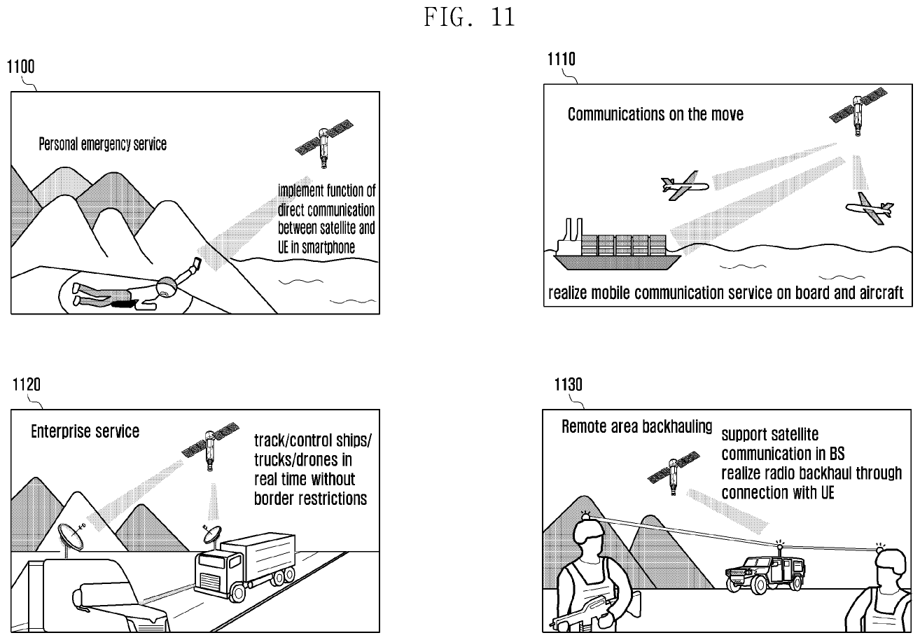

FIG. 11 illustrates a scenario using direct communication between a satellite and a UE. The direct communication between the satellite and the UE can support a communication service specialized to compensate the coverage limit of a ground network. For example, by implementing a function of the direct communication between the satellite and the UE in the UE, satellite communication can be used to make emergency relief of the user or/and transmission and reception of a disaster signal possible in a place other than the ground network communication coverage as indicated by reference numeral 1100, provide a mobile communication service to the user in an area in which ground network communication is impossible such as on a boat or/and aircraft as indicated by reference 1110, track and control locations of ships, trucks, or/and drones in real time without border restrictions as indicated by reference numeral 1120, and perform a backhaul function in a physically remote area by supporting a satellite communication function in the BS and functioning as a backhaul of the BS as indicated by reference numeral 1130.

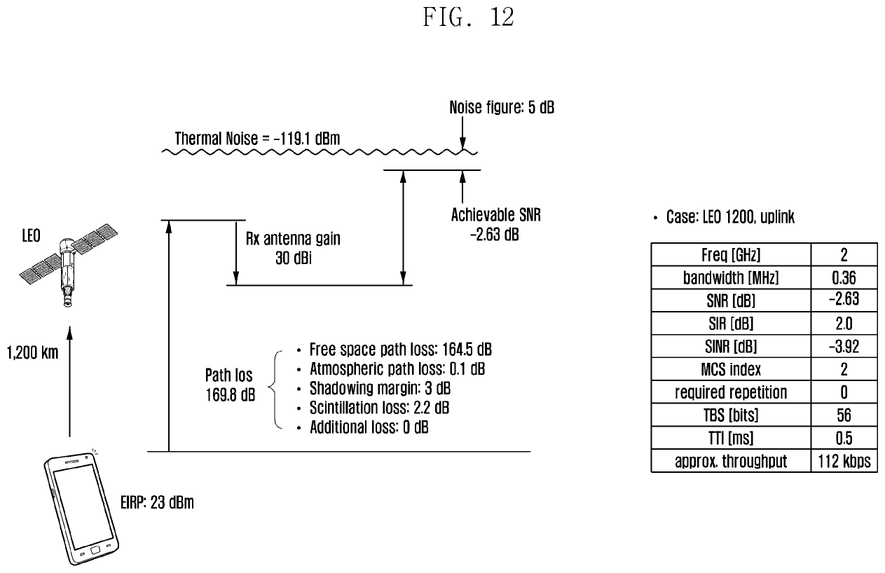

FIG. 12 illustrates an example of calculation of expected data throughput in the uplink when the LEO satellite having an altitude of 1200 km and the UE perform direct communication. When effective isotropic radiated power (EIRP) of the ground UE in the uplink is 23 dBm, a path loss of a radio channel to the satellite is 169.8 dB, and a satellite reception antenna gain is 30 dBi, an achievable signal-to-noise ratio (SNR) is estimated as −2.63 dB. In this case, the path loss may include a path loss in the space, a path loss in the atmosphere, and the like. When it is assumed that a signal-to-interference ratio (SIR) is 2 dB, a signal-to-interference and noise ratio (SINR) is calculated as −3.92 dB, in which case a transmission rate of 112 kbps can be achieved when subcarrier spacing of 30 kHz and frequency resources of 1 PRB are used.

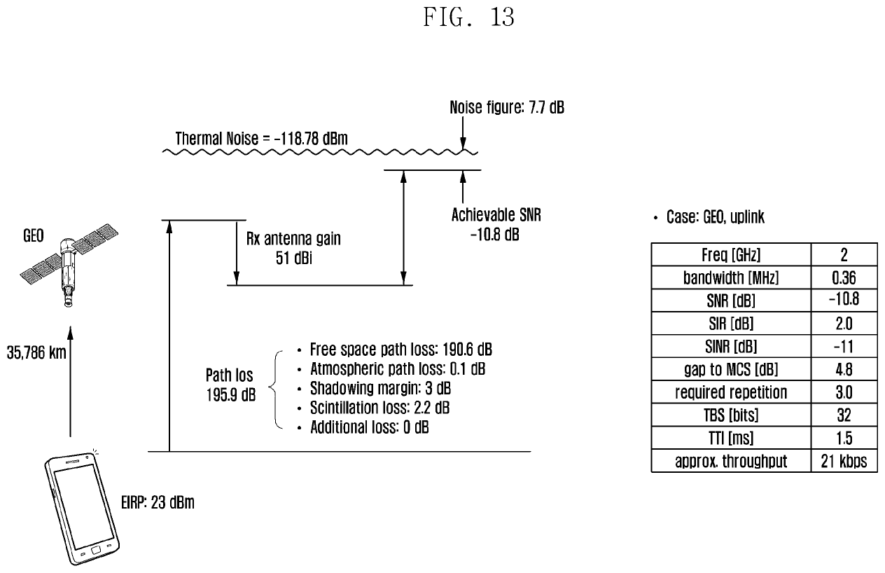

FIG. 13 illustrates an example of calculation of expected data throughput in the uplink when the GEO satellite having an altitude of 35,786 km and the ground UE perform direct communication. When EIRP of the ground UE in the uplink is 23 dBm, a path loss of a radio channel to the satellite is 195.9 dB, and a satellite reception antenna gain is 51 dBi, an achievable SNR is estimated as −10.8 dB. In this case, the path loss may include a path loss in the space, a path loss in the atmosphere, and the like. When it is assumed that the SIR is 2 dB, the SINR is calculated as −11 dB, in which case a transmission rate of 21 kbps can be achieved when subcarrier spacing of 30 kHz and frequency resources of 1 PRB are used, which is the result of 3 repeated transmissions.

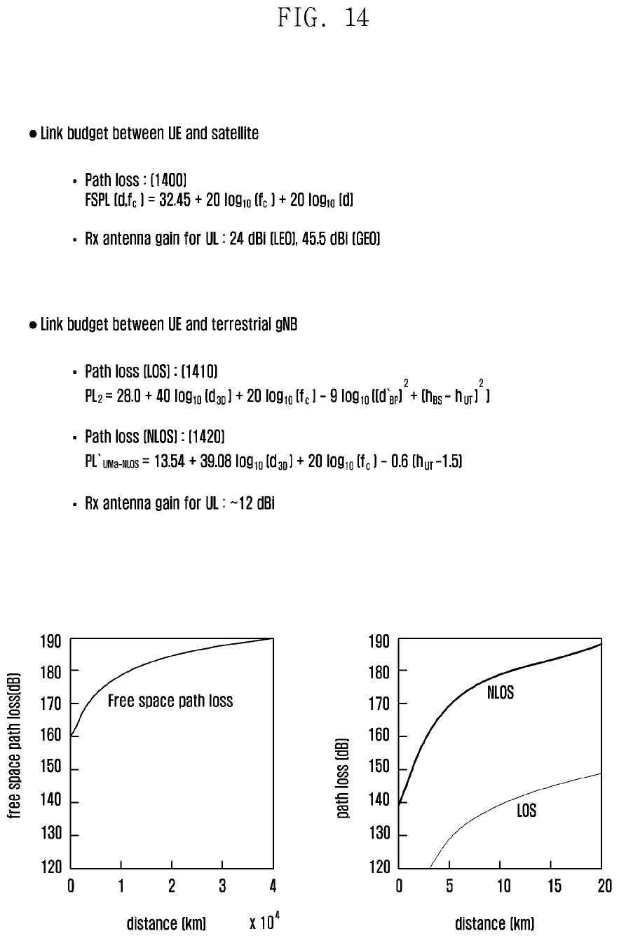

FIG. 14 illustrates a path loss value according to a path loss model between a UE and a satellite and a path loss according to a path loss model between the UE and a ground network communication BS. In FIG. 14, d is a distance and fc is a frequency of a signal. A path loss 1400 (FSPL) in a free space in which communication between the UE and the satellite is performed is inversely proportional to the square of the distance, but path losses 1410 and 1420 (PL₂ and PL_{′Uma-NLOS}) on the ground on which air exists and communication between the UE and a ground network communication BS (terrestrial gNB) is performed is inversely proportional almost to 4th power of the distance. d_{3D} is a straight-line distance between the UE and the BS, hBS is a height of the BS, and h_{UT} is a height of the UE. It is calculated that d′_{BP}=4×h_{BS}×h_{UT}×f_{c}/c, f_{c} is a central frequency in units of Hz and c is a speed of light in units of m/s.

In a satellite communication network (or a non-terrestrial network), Doppler shift, that is, frequency movement (offset) of a transmission signal is generated due to continuous fast movement of the satellite.

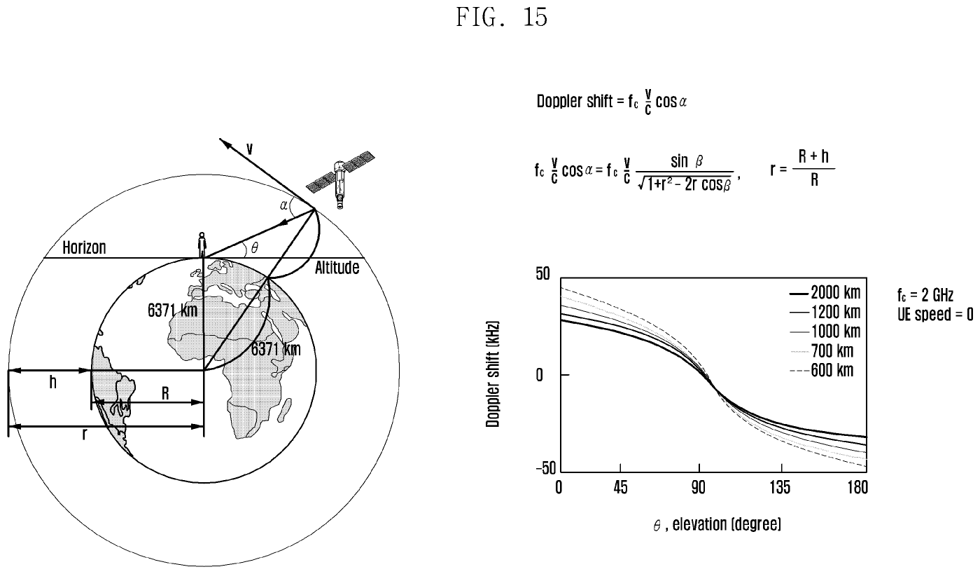

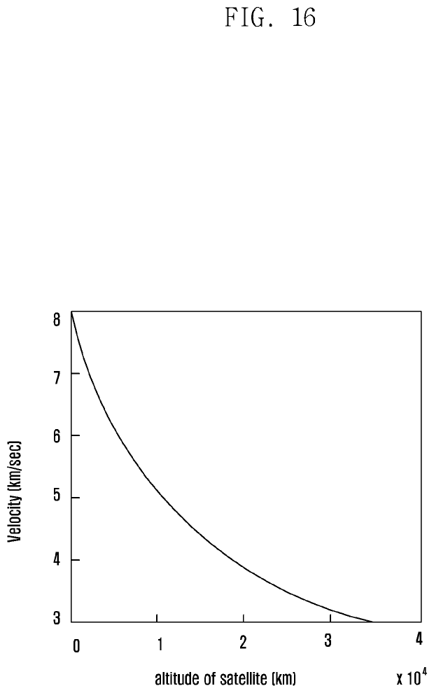

FIG. 15 illustrates an equation of calculating an amount of the Doppler shift which a signal experiences and the result thereof when the signal transmitted from the satellite is received by a user on the ground according to altitude and a location of the satellite, and a location of the user of the UE on the ground. An earth radius is R, h is an altitude of the satellite, v is a velocity of revolution of the satellite around the earth, and fc is a frequency of a signal. The velocity of the satellite may be calculated by the altitude of the satellite, which corresponds to a velocity making the gravity that is the force which causes the earth to pull the satellite the same as the centripetal force generated according to the revolution of the satellite, and may be calculated as shown in FIG. 16.

FIG. 16 illustrates a velocity of a satellite calculated at an altitude of the satellite. As identified in FIG. 15, an angle α is determined by an elevation angle θ, and thus a value of Doppler shift is determined according to the elevation angle θ.

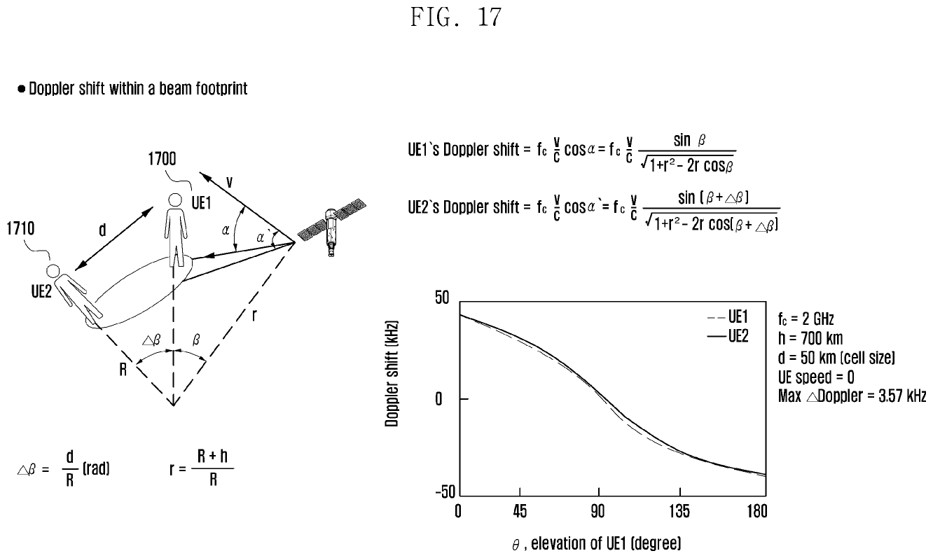

FIG. 17 illustrates Doppler shift which different UEs in one beam which a satellite transmits to the ground experience. In FIG. 17, Doppler shifts which UE #1 1700 and UE #2 1710 experience according to an elevation angle θ are calculated. It is the result of the assumption that the center frequency is 2 GHz, a satellite altitude is 700 km, a radius of one beam on the ground is 50 km, and a speed of the UE is 0. Further, the Doppler shift calculated in the disclosure ignores an effect according to a speed of earth rotation, which may be considered as small influence because the speed is slow compared to a speed of the satellite.

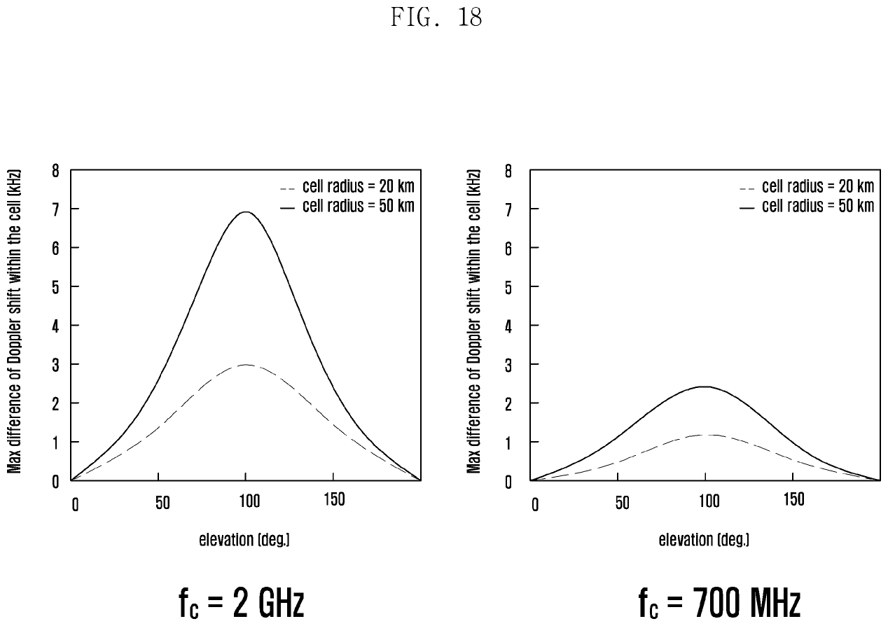

FIG. 18 illustrates difference between Doppler shifts generated within one beam according to a location of a satellite determined by an elevation angle. When the satellite is located right on the beam, that is, when an elevation angle is 90 degrees, the difference between Doppler shifts is the largest within the beam (or cell). This is because, when the satellite is located at the top in the middle, Doppler shift values on one end and the other end of the beam have a positive value and a negative value, respectively.

Meanwhile, since the distance between the satellite and a user on the ground is long in satellite communication, the satellite communication has a longer delay time compared to ground network communication.

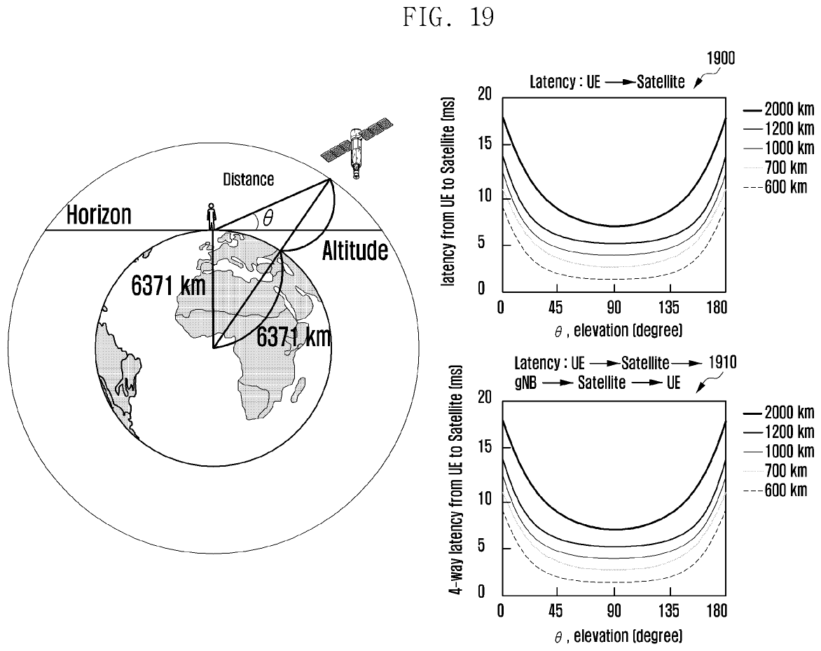

FIG. 19 illustrates a delay time from a UE to a satellite according to a location of the satellite determined by an elevation angle and a round-trip delay time between the UE, the satellite, and a BS. Reference numeral 1900 indicates a delay time from the UE to the satellite, and reference numeral 1910 indicates a round-trip delay time between the UE, the satellite, and the BS. At this time, it is assumed that the delay time between the satellite and the BS and the delay time between the UE and the satellite are the same as each other.

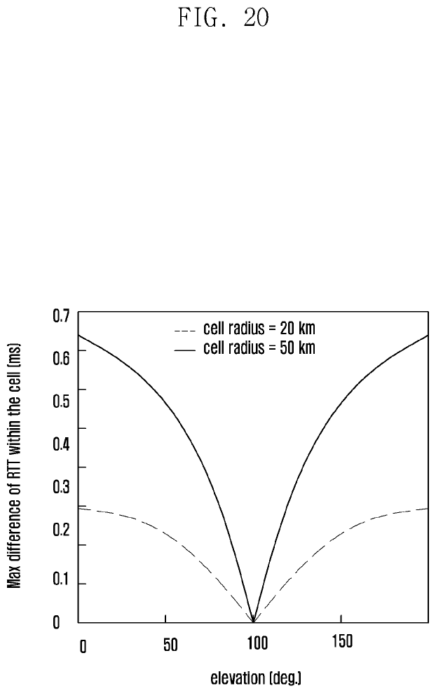

FIG. 20 illustrates a maximum difference value of a round-trip delay time varying depending on a location of a user within one beam. For example, when a beam radius (or cell radius) is 20 km, a difference between round-trip delay times between UEs at difference locations within the beam and the satellite may be equal to or smaller than about 0.28 ms according to the location of the satellite.

Transmission and reception of a signal with the BS by the UE in satellite communication may mean delivery of the signal through the satellite. That is, the satellite may serve to receive a signal, which the BS transmits to the satellite, and then transmits the signal to the UE in the downlink, and serve to receive a signal, which the UE transmits to the satellite, and then transmits the signal to the BS in the uplink. The satellite may receive the signal and then transmit the signal after performing only frequency shift or may perform signal processing such as decoding and re-encoding based on the received signal and then transmit the signal.

In the case of LTE or NR, the UE may access the BS through the following procedure.
Step 1: the UE receives a synchronization signal (or synchronization signal block (SSB) including a broadcasting signal) from the BS. The synchronization signal may include a primary synchronization signal (PSS), a secondary synchronization signal (SSS), and a physical broadcast channel (PBCH). The synchronization signal may include information on a slot boundary of a signal which the BS transmits, a frame number, a downlink, an uplink configuration, and the like. Further, through the synchronization signal, the UE may acquire a subcarrier offset, scheduling information for transmitting system information, and the like.
Step 2: the UE receives system information (system information block (SIB)) from the BS. The SIB may include information for performing initial access and random access. Information for performing random access may include resource information for transmitting a random access preamble.
Step 3: a random access preamble (or message 1 (msg1)) is transmitted in random access resources configured in step 2. The preamble may be a signal determined on the basis of the information configured in step 2 using a predetermined progression. The BS receives the preamble transmitted by the UE. The UE may attempt reception of the preamble configured in resources which the BS configures without knowing which UE transmitted the preamble and, when the reception is successful, may know that at least one UE transmitted the preamble.
Step 4: when the preamble is received in step 3, the BS transmits a random access response (RAR) (or message 2 (msg2)) corresponding to a response thereto. The UE transmitting the random access preamble in step 3 may attempt reception of the RAR transmitted by the BS in this step. The RAR is transmitted on a PDSCH, and a PDCCH for scheduling the PDSCH is transmitted together or in advance. A CRC scrambled by an RA-RNTI is added to DCI for scheduling the RAR, and the DCI (and CRC) is channel-coded and then mapped to the PDCCH and transmitted. The RA-RNTI may be determined on the basis of a time at which the preamble is transmitted in step 3 and frequency resources.

A maximum limit time until the UE transmitting the random access preamble in step 3 receives the RAR in this step can be configured in the SIB transmitted in step 2. This may be restrictively configured as, for example, a maximum of 10 ms or 40 ms. That is, when the UE transmitting the preamble in step 3 does not receive the RAR within a time determined on the basis of, for example, the configured maximum time 10 ms, the preamble may be transmitted again. The RAR may include scheduling information for allocating resources of the signal to be transmitted by the UE in step 5 that is the following step.

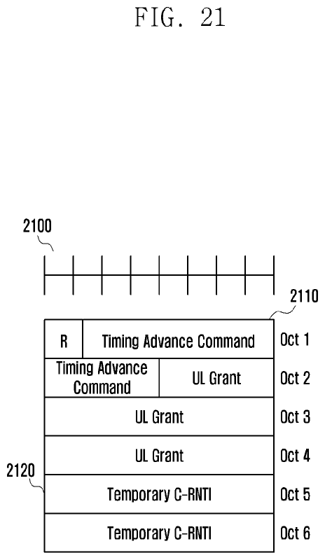

FIG. 21 illustrates an example of the information structure of an RAR. An RAR 2100 may be, for example, a MAC PDU, and may include information 2110 on timing advance (TA) to be applied by the UE and a temporary C-RNTI 2120 to be used in the following step.
Step 5: the UE receiving the RAR in step 4 transmits message 3 (msg3) to the BS according to scheduling information included in the RAR. The UE may insert its own unique ID into msg3 and transmit the msg3. The BS may attempt reception of msg3 according to the scheduling information which the BS transmitted in step 4.
Step 6: after receiving msg3 and identifying ID information of the UE, the BS generates message 4 (msg4) including the ID information of the UE and transmits the same to the UE. The UE transmitting msg3 in step 5 may attempt reception of msg4 to be transmitted in step 6 thereafter. The UE receiving msg4 may compare the ID included in msg4 after decoding with the ID which the UE transmitted in step 5 and identify whether msg3 which the UE transmitted is received by the BS. There may be a limit on a time to reception of msg4 in this step after the UE transmitted msg3 in step 5, and the maximum time may be configured by the SIB in step 2.

When the initial access procedure using the steps is applied to satellite communication, a propagation delay time in the satellite communication may be a problem. For example, a period (random access window) from transmission of the random access preamble (or PRACH preamble) by the UE in step 3 to reception of the RAR in step 4, that is, a maximum time to the reception thereof may be configured through ra-ResponseWindow, and the maximum time in the conventional LTE or 5G NR system may be configured up to a maximum of 10 ms.

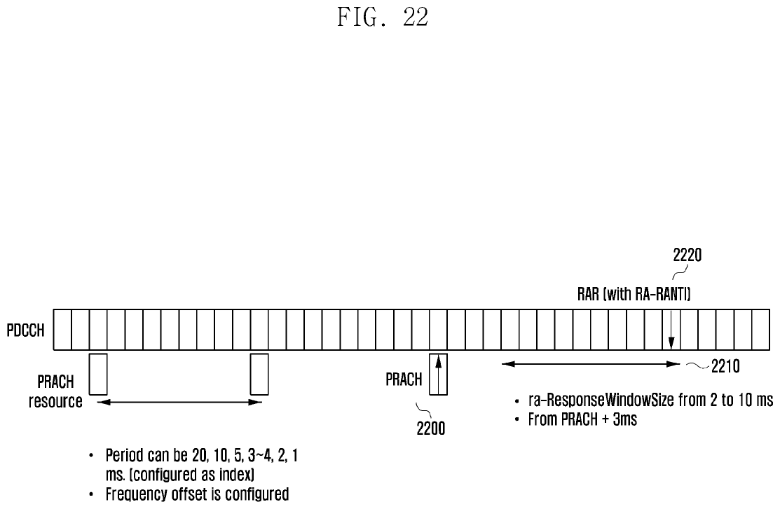

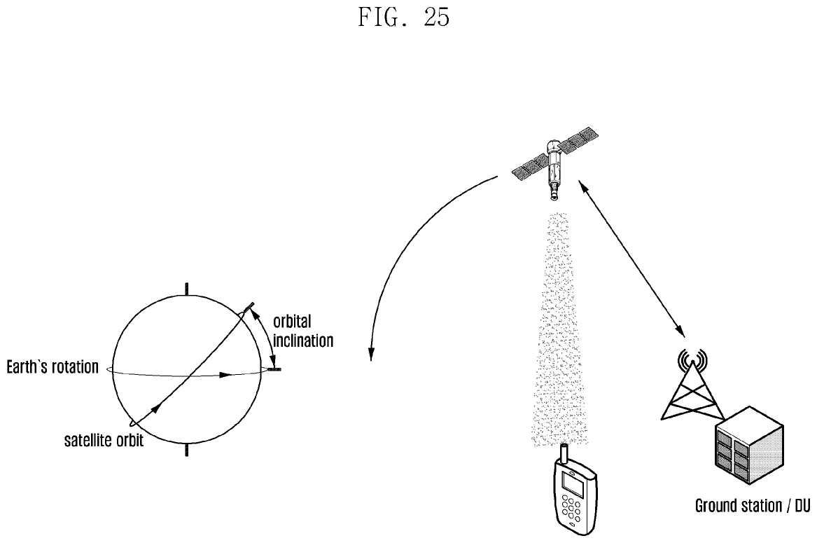

FIG. 22 illustrates an example of the relation between PRACH preamble configuration resources and an RAR reception time point in the LTE system, and FIG. 25 illustrates an example of the relation between PRACH preamble configuration resources and an RAR reception time point in the 5G NR system. Referring to FIG. 22, in the case of LTE, a random access window 2210 starts at a time point after 3 ms from transmission 2200 of a PRACH (random access preamble), and when the UE receives an RAR within the random access window, as indicated by reference numeral 2220, it may be determined that transmission of the PRACH preamble is successful.

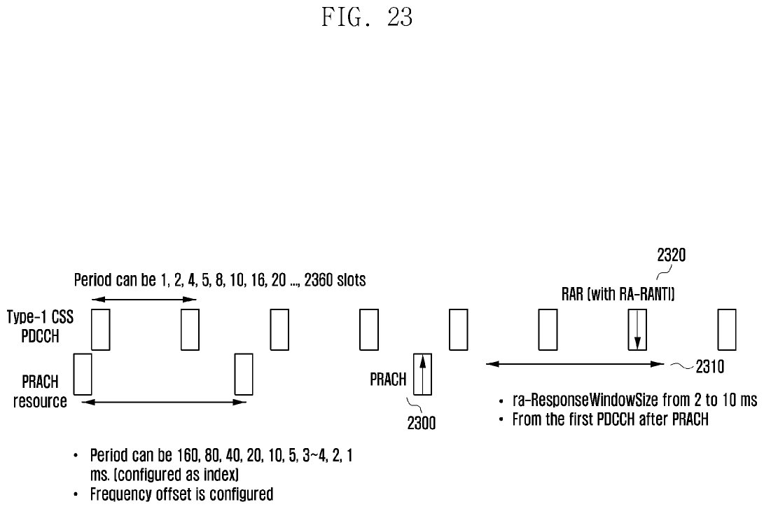

Referring to FIG. 23, in the case of NR, a random access window 2310 starts at a control information area for RAR scheduling that first appears after transmission 2300 of the PRACH (random access preamble). When the UE receives the RAR within the random access window as indicated by reference numeral 2320, it may be determined that transmission of the PRACH preamble is successful.

For example, TA for uplink transmission timing in the 5G NR system may be determined as follows. T_{c}=1/(Δfₘₐₓ·N_{f}) where Δfₘₐₓ=480·10³ Hz and Nf=4096. Further, κ=Tₛ/T_{c}=64, and Tₛ=1/(Δf_{ref}·N_{f,ref}), Δf_{ref}=15·10³ Hz, and N_{f,ref}=2048 may be defined.

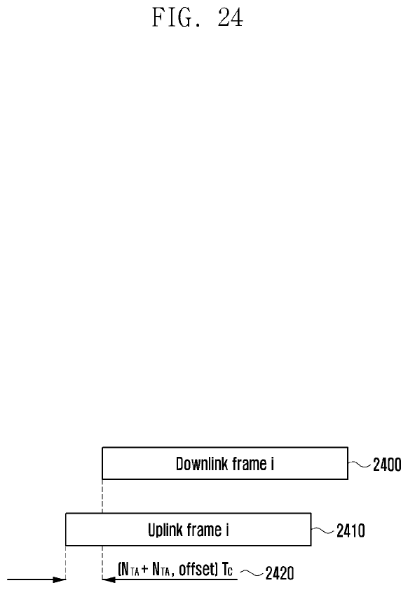

FIG. 24 illustrates an example of timing of a downlink frame and an uplink frame for the UE. The UE may advance an uplink frame 2410 by T_{TA}=(N_{TA}+N_{TA,offset})T_{c} 2420 from the time point of a downlink frame 2400 and perform uplink transmission. A value of N_{TA} may be transmitted through an RAR or may be determined on the basis of a MAC CE, and N_{TA,offset} may be a value configured in the UE or determined on the basis of a predetermined value.

T_{A} may be indicated by the RAR of the 5G NR system, in which case Tₛ may indicate one of 0, 1, 2, . . . , 3846. In this case, when subcarrier spacing (SCS) of the RAR is 2^{μ}·15 kHz, N_{TA} is determined as N_{TA}=T_{A}·16·64/2^{μ}. After the UE completes the random access process, a change value of TA may be indicated from the BS through a MAC CE or the like. T_{A} information indicated through the MAC CE may indicate one of 0, 1, 2, . . . , 63, which may be used to calculate a new TA value by being added to or subtracted from the existing TA value, and the resultant TA value may be newly calculated as a T_{TA_new}=N_{TA_old}+(T_{A}−31)·16·64/2^{μ}. The indicated TA value may be applied to uplink transmission by the UE after a predetermined time.

FIG. 25 illustrates an example of continuous movement of a satellite with respect to the ground of the earth or a UE located on the earth according to revolution of the satellite along a satellite orbit around the earth. Since the distance between the UE and the satellite varies depending on an elevation angle at which the UE views the satellite, the propagation delay between the UE, the satellite, and the BS may be different.

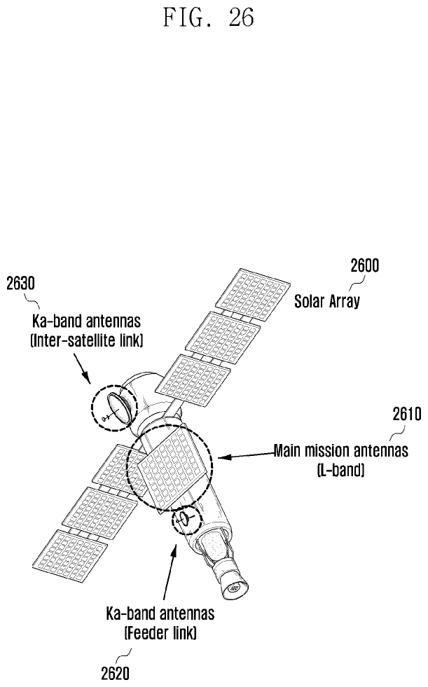

FIG. 26 illustrates an example of the structure of an artificial satellite. The satellite may include a solar panel or a solar array 2600 for solar thermal or solar power generation, a transmission and reception antenna (main mission antenna) 2610 for communication with the UE, a transmission and reception antenna (feeder link antenna) 2620 for communication with the ground station, a transmission and reception antenna (inter-satellite link) 2630 for communication between satellites, and a processor for controlling transmission and reception and processing a signal. When communication between satellites is not supported according to the satellite, the antenna for signal transmission and reception between satellites may not be arranged. Although FIG. 26 illustrates that an L band of 1 to 2 GHz is used for communication with the UE, a K band (18 to 26.5 GHz), a Ka band (26.5 to 40 GHz), and a Ku band (12 to 18 GHz) corresponding to high-frequency bands may be used.

Meanwhile, various embodiments of the disclosure provides a method and an apparatus for controlling uplink timing in the communication system, and a detailed description thereof is made below.

First, in various embodiments of the disclosure, in order to make uplink signals transmitted from other UEs for time synchronization arrive at the BS at the same time, time points at which the uplink signals are transmitted may be differently configured according to the location of each UE, and timing advance (TA) is used therefor. For example, the TA is used to control uplink timing, for example, uplink frame timing for downlink timing, for example, downlink frame timing.

Further, in various embodiments of the disclosure, the TA may be transmitted through a MAC CE, for example, a timing advance command MAC CE, an absolute timing advance command MAC CE, or the like.

In addition, various embodiments of the disclosure provide an apparatus and a method for transmitting and receiving a signal on the basis of the TA in the communication system.

Various embodiments of the disclosure provide an apparatus and a method for transmitting and receiving a signal on the basis of the TA when a non-terrestrial network (NTN) is considered in the communication system.

Various embodiments of the disclosure provide a method and an apparatus for performing an uplink transmission operation by the UE on the basis of the TA in the communication system. Accordingly, the BS may transmit in advance information for assisting the UE in applying the TA or reception of an uplink signal which the UE transmits after the application of the TA.

Various embodiments of the disclosure consider the case in which the UE transmits and receives a signal to and from the BS through a satellite and provide an apparatus and a method for transmitting and receiving a signal by applying the TA on the basis of information provided from the BS and the satellite or global navigation satellite system (GNSS) information in order to perform initial access of the UE, data transmission, and the like.

In various embodiments of the disclosure, the term “base station (BS)” may indicate a predetermined component (or a set of components) configured to provide radio access, such as a transmission point (TP), a transmit-receive point (TRP), an enhanced node B (eNodeB or eNB), a 5G base station (gNB), a macro cell, a femto cell, a WiFi access point (AP), or other wireless enable devices. The BSs may provide radio access according to one or more wireless protocols, for example, 5G 3GPP new wireless interface/access (NR), long-term evolution (LTE), LTE-advanced (LTE-A), high-speed packet access (HSPA), Wi-Fi 802.11a/b/g/n/ac, and the like.

In various embodiments of the disclosure, the term “terminal” may indicate a predetermined component such as “user equipment (UE),” “mobile station,” “subscriber station,” “remote terminal,” “wireless terminal,” “receive point,” or “user device.” For convenience, the term “terminal” is used to indicate a device accessing the BS in various embodiments of the disclosure regardless of whether the terminal may be considered as a mobile device (mobile phone or smartphone) or a stationary device (for example, desktop computer or vending machine).

In various embodiments of the disclosure, the term “TA” may be used interchangeably with “TA information,” “TA value,” “TA index,” or the like.

In various embodiments of the disclosure, data or control information which the BS transmits to the UE may be referred to as a first signal, and an uplink signal associated with the first signal may be referred to as a second signal. For example, the first signal may include DCI, a UL grant, a PDCCH, a PDSCH, an RAR, and the like, and the second signal associated with the first signal may include a PUCCH, a PUSCH, msg3, and the like.

There may be association between the first signal and the second signal. For example, when the first signal is a PDCCH including a UL grant for uplink data scheduling, the second signal corresponding to the first signal may be a PUSCH including uplink data. Meanwhile, a gap between time points at which the first signal and the second signal are transmitted and received may be a predetermined value between the UE and the BS. Unlike this, a gap between time points at which the first signal and the second signal are transmitted and received may be determined by an indication of the BS or determined by a value transmitted through higher-layer signaling.

Meanwhile, a satellite navigation system may also be called a GNSS, and the GNSS may include, for example, a GPS in the US, a GLONASS in Russia, Galileo in EU, Beidou in China, and the like. The GNSS may include a regional navigation satellite system (RNSS), and the RNSS may include, for example, IRNSS in India, QZSS in Japan, KPS in Korea, and the like. Meanwhile, a signal transmitted by the GNSS may include at least one of supplementary navigation information, a normal operation state of a satellite, a satellite time, satellite orbital power, a satellite altitude, a reference time, and information on various compensation documents.

The UE may receive a signal from each of one or more GNSS satellites, calculate the location of the UE on the basis of the signal received from each of the one or more GNSS satellites, and identify a reference time in each of the one or more GNSS satellites. When the UE may calculate a plurality of locations of the UE on the basis of the signals received from a plurality of GNSS satellites, the UE may calculate the real location of the UE on the basis of an average of the plurality of locations, a location corresponding to a received signal having the highest strength among the plurality of locations, an average value of the plurality of locations based on a signal strength (for example, a method of applying a weighted value in the location corresponding to the signal having the high signal strength), or the like. A scheme in which the UE calculates the location of the UE on the basis of the signals received from the plurality of GNSS satellites may be implemented in various forms, and a detailed description thereof is omitted.

As described above, the UE may calculate a time spent while the signal is transmitted from an NTN satellite to the UE on the basis of the location of the UE calculated by the UE and the location of the NTN satellite received from the NTN satellite and determine a TA value on the basis thereof. If a distance from the NTN satellite to the BS on the ground or the corresponding signal is transmitted to the BS on the ground via another NTN satellite when the UE determines the TA value, the UE may also consider the distance from the NTN satellite to another NTN satellite.

Unlike this, the UE may acquire reference time information from information transmitted by the GNSS satellite, compare time information transmitted by the NTN satellite with reference time information acquired from the GNSS satellite, and calculate a time (propagation delay) from the NTN satellite to the UE on the basis of the comparison result.

In the 5G system, two types such as a PUSCH repetitive transmission type A and a PUSCH repetitive transmission type B are supported as the repetitive transmission method of the uplink data channel.

In one embodiment, a PUSCH repetitive transmission type A is provided.

As described above, the length of the uplink data channel (the number of symbols or the number of slots) and the start symbol may be determined through a time domain resource allocation method within one slot, and the BS may notify the UE of the number of repetitive transmissions through higher-layer signaling (for example, MAC CE signaling or RRC signaling) or L1 signaling (for example, DCI). In the disclosure, L1 signaling may be a signal transmitted from a physical layer.

The UE may repeatedly transmit uplink data channels having the configured same uplink data channel length and start symbol in successive slots on the basis of the number of repetitive transmissions received from the BS. At this time, when slots which the BS configures as the downlink in the UE or one or more symbols among the symbols of uplink data channels configured in the UE are configured as the downlink, the UE omits uplink data channel transmission. That is, even though it is included in the number of repetitive transmissions of the uplink data channel, the UE does not transmit the uplink data channel.

In one embodiment, a PUSCH repetitive transmission type B is provided.

As described above, the start symbol and the length of the uplink data channel (the number of symbols or the number of slots) may be determined through the time domain resource allocation method within one slot, and the BS may notify the UE of number of repetitions corresponding to the number of repetitive transmissions through higher-layer signaling (for example, RRC signaling) or L1 signaling (for example, DCI).
The nominal repetition of the uplink data channel is determined on the basis of the start symbol and the length of the configured uplink data channel. A slot in which nth nominal repetition starts is given by

$${K}_{s} + ⌊ \frac{S + n \cdot L}{{N}_{symb}^{slot}} ⌋ ,$$

and a symbol starting at the slot is given by mod(S+n·L, N_{symb}^{slot}). A slot in which nth nominal repetition ends is given by

$${K}_{s} + ⌊ \frac{S + ( n + 1 ) \cdot L}{{N}_{symb}^{slot}} ⌋ ,$$

and a symbol ending at the slot is given by mod(S+(n+1)·L−1, N_{symb}^{slot}). n=0, . . . , numberofrepetitions−1, S is a start symbol of the configured uplink data channel, and L is a length of symbols of the configured uplink data channel. Ks is a slot in which PUSCH transmission starts, and N_{symb}^{slot} is the number of symbols per slot.

The UE determines an invalid symbols for the PUSCH repetitive transmission type B. A symbol configured as the downlink by tdd-UL-DL-ConfigurationCommon or tdd-UL-DL-ConfigurationDedicated is determined as an invalid symbol for the PUSCH repetitive transmission type B. In addition, the invalid symbol may be configured by a higher-layer parameter (for example, InvalidSymbolPattern). The higher-layer parameter (for example, InvalidSymbolPattern) configures the invalid symbol by providing a symbol level bit map over one or two slots. In the bitmap, 1 indicates an invalid symbol. In addition, a period and a pattern of the bitmap may be configured through a higher-layer parameter (for example, periodicityAndPattern). When the higher-layer parameter (for example, InvalidSymbolPattern) is configured, the UE applies an invalid symbol pattern if an InvalidSymbolPatternIndicator-ForDCIFormat0_1 or InvalidSymbolPatternIndicator-ForDCIFormat0_2 parameter indicates 1, or the UE may not apply the invalid symbol pattern if the parameter indicates 0. When the higher-layer parameters (for example, InvalidSymbolPattern) is configured and the InvalidSymbolPatternIndicator-ForDCIFormat0_1 or InvalidSymbolPatternIndicator-ForDCIFormat0_2 is not configured, the UE applies the invalid symbol pattern.

After the invalid symbol is determined in each nominal repetition, the UE may consider the remaining symbols as valid symbols. When one or more valid symbols are included in each nominal repetition, the nominal repetition may include one or more actual repetitions. Each actual repetition includes successive sets of valid symbols which can be used for the PUSCH repetitive transmissions type B in one slot.

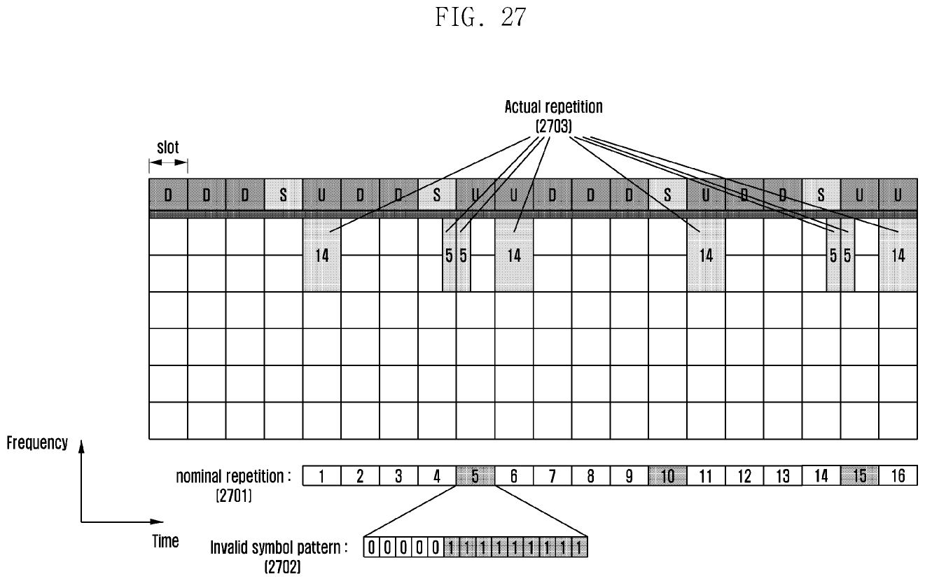

FIG. 27 illustrates an example of the PUSCH repetitive transmission type B in the 5G or NR system.

In FIG. 27, D is a downlink slot, U is an uplink slot, and S corresponds to a slot including both uplink and downlink symbols. The UE may receive a configuration of a start symbol S of an uplink data channel to have symbol index 0 within the slot, a length L of the uplink data channel to be 14, and the number of repeated transmissions to be 16. In this case, nominal repetition appears in 16 successive slots as indicated by reference numeral 2701. Thereafter, the UE may determine a symbol configured as a downlink symbol in each nominal repetition 2701 as an invalid symbol. Further, the UE determines symbols configured as 1 in an invalid symbol pattern 2702 as invalid symbols. When valid symbols other than the invalid symbol in each nominal repetition includes one or more successive symbols in one slot, the valid symbols are configured as actual repetition and transmitted as indicated by reference number 2703.

An uplink/downlink signal or channel transmission/reception procedure of the UE may be largely divided into two procedures below. The UE may receive DCI transmitted through a downlink control channel (for example, a PDCCH) from the BS and perform uplink/downlink transmission and reception (for example, PDSCH or PUSCH) according to the received DCI. In the disclosure, the scheme in which the UE receives the DCI and performs the uplink/downlink transmission and reception according to the received DCI is referred to as a first uplink/downlink transmission and reception scheme or a first transmission and reception type. Another uplink/downlink transmission and reception method is a method by which the UE may transmit and receive an uplink/downlink signal or channel according to transmission and reception configuration information configured through a higher-layer signal or the like without separate DCI reception from the BS and may include a semi-persistent scheduling (SPS), grant-free, or configured grant scheme. In the disclosure, the scheme in which the UE performs uplink/downlink transmission and reception without DCI reception is referred to as a second uplink/downlink transmission and reception scheme or a second transmission and reception type. At this time, second uplink/downlink transmission and reception of the UE may start after the UE receives DCI indicating activation of second uplink/downlink transmission and reception configured through a higher-layer signal from the BS. If the UE receives DCI indicating release of the second uplink/downlink transmission and reception from the BS, the UE may not perform the configured second uplink/downlink transmission and reception. In the above scheme, configuration information for the second transmission and reception type are all received using the higher-layer signal and the DCI, and the scheme is identified as a second transmission and reception type of type 2.

Meanwhile, as described above, the UE may determine activation of second uplink/downlink transmission and reception right after receiving the higher-layer signal related to the second uplink/downlink transmission and reception without separate DCI reception for activation or release of the second uplink/downlink transmission and reception of the UE. Similarly, the BS may release the second uplink/downlink transmission and reception configured in the UE through reconfiguration of the higher-layer signal related to the second uplink/downlink transmission and reception, in which case the UE may not perform the configured second uplink/downlink transmission and reception. In the above scheme, configuration information for the second transmission and reception type is all received only through the higher-layer signal, and the scheme may be identified as a second transmission and reception type of type 1.

The second transmission and reception type is divided for the downlink and uplink and described below in more detail.

The second transmission and reception type for the downlink is a method by which the BS periodically transmits a downlink data channel to the UE on the basis of information configured through higher-layer signaling without DCI transmission. The second transmission and reception type for the downlink is mainly used when a voice over Internet protocol (VoIP) or periodically generated traffic is transmitted and a downlink data channel can be transmitted without DCI transmission, thereby minimizing the overhead.

The UE may receive configuration information for downlink reception of the following second transmission and reception type from the BS through the higher-layer signal.
Periodicity: indicates a period of the second transmission and reception type.
nrofHARQ-Processes: indicate the number of HARQ processes configured for the second transmission and reception type.
n1PUCCH-AN: indicates HARQ resource configuration information for transmitting a reception result of a PDSCH received through the second transmission and reception type to the BS.
mcs-Table: indicates modulation and coding scheme (MCS) table configuration information applied to transmission of the second transmission and reception type.

Similarly, the UE may receive configuration information for uplink transmission of the following second transmission and reception type from the BS through the higher-layer signal.
frequencyHopping: indicates a field indicating intra-slot hopping or inter-slot hopping, and deactivates frequency hopping when this field does not exist.
cg-DMRS-Configuration: indicates DMRS configuration information.
mcs-Table: indicates a field informing whether a 256 QAM MCS table is used or a new 64 QAM MCS table is used for PUSCH transmission without transform precoding, and the 64 QAM MCS table is used when this field does not exist.
mcs-TableTransformPrecoder: indicates a field informing of an MCS table used by the UE in transform precoding-based PUSCH transmission, and the 64 QAM MCS table is used when this field does not exist.
uci-OnPUSCH: applies a beta-offset through one of dynamic or semi-static schemes.
resourceAllocation: configures whether a resource allocation type is 1 or 2.
rbg-Size: determines one of two configurable RBG sizes.
powerControlLoopToUse: determines whether to apply closed loop power control.
p0-PUSCH-Alpha: applies Po and a PUSCH alpha value.
transformPrecoder: configures whether to apply transformer precoding and follows msg3 configuration information when this field does not exist.
nrofHARQ-Processes: indicates the number of configured HARQ processes.
repK: indicates the number of repetitive transmissions.
repK-RV: indicates an RV pattern applied to each repetitive transmission in repetitive transmission, and is deactivated when the number of repetitive transmissions is 1.
periodicity: indicates a transmission period and exists from a minimum of two symbols to a maximum of slot units from 640 to 5120 according to subcarrier spacing.
configuredGrantTimer: indicates a timer for guaranteeing retransmission and is configured in units of a plurality of periodicities.

At this time, in type 1 of the second transmission and reception type, the UE may additionally receive the following configuration information from the BS through a higher signal (for example, rrc-ConfiguredUplinkGrant). In type 2 of the second transmission and reception type, the UE may receive the following configuration information through DCI.
timeDomainOffset: indicates a value indicating a first slot in which uplink transmission of the second transmission and reception type is initiated and corresponds to information in units of slots based on system frame number (SFN) 0.
timeDomainAllocation: indicates a field informing of an uplink transmission time resource area of the second transmission and reception type and corresponds to startSymbolAndLength or a start and length indicator value (SLIV).
frequencyDomainAllocation: indicates a field informing of an uplink transmission frequency resource area of the second transmission and reception type.
antennaPort: indicates antenna port configuration information applied to uplink transmission of the second transmission and reception type.
dmrs-SeqInitialization: indicates a field configured when a transform precoder is deactivated.
precodingAndNumberOfLayers.
srs-ResourceIndicator: indicates a field informing of SRS resource configuration information.
mcsAndTBS: indicates an MCS and a TBS applied to uplink transmission of the second transmission/reception type.
frequencyHoppingOffset: indicates a value of frequency hopping offset.
pathlossReferenceIndex.

At this time, the UE may configure repetitive transmission of one TB a maximum of repK times through the second uplink transmission scheme. repK is a value which can be configured through a higher-layer signal, and the UE in which repK is configured or the UE in which repK is configured as a value larger than 1 may transmit the TB repeatedly repK times. At this time, in the case of an uplink data channel, one of the two types of repetitive transmission method, that is, the PUSCH repetitive transmission type A and the PUSCH repetitive transmission type B may be configured in the second uplink transmission like in the first uplink transmission. The UE may receive a configuration of a maximum value of repK through a higher signal and may receive a value repK′ which the UE may repeatedly transmit in DCI for activating the second uplink transmission scheme. repK′ may be a value equal to or smaller than repK. repK is initial transmission of the TB transmitted through the second uplink transmission scheme or the number of transmissions including the initial transmission, and may have one of the values including 1 (for example, repK=1,2,4,8,16). At this time, the values of repK are examples, and are not limited thereto. The UE determines a redundancy version (RV) value for nth transmission among repK transmissions as a (mod(n−1,4)+1)th value among configured RV sequences, repK-RV values. n=1, 2, . . . , K, and K is the number of actual repetitive transmissions.

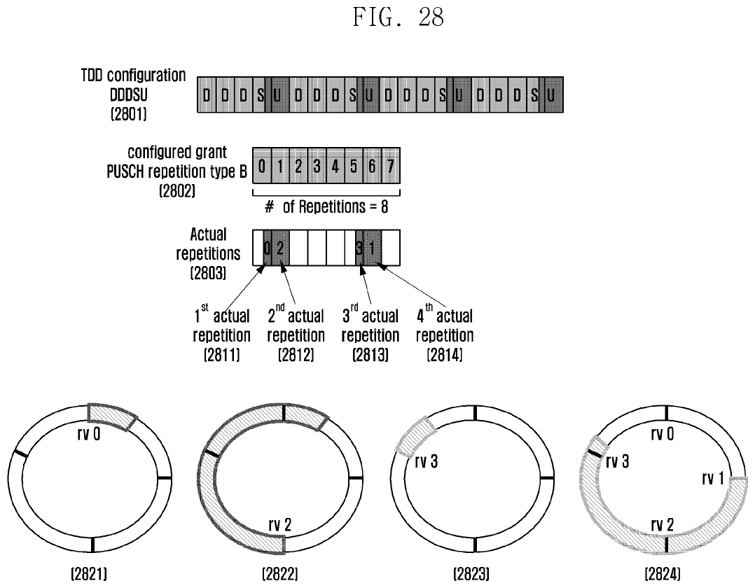

FIG. 28 illustrates an example of the repetitive transmission type B of the second uplink transmission in a TDD system.

A frame structure configuration of a time division duplexing (TDD) system applied to the UE may include 3 downlink slots, 1 special/flexible slot, and 1 uplink slot. When the special or flexible slot includes 11 downlink symbols and 3 uplink symbols, an initial transmission slot in second uplink transmission is a third slot, the UE receives a configuration such that a start symbol of an uplink data channel is 0 and a length is 14, and when the number repK of repetitive transmissions is 8, the nominal repetition appears in 8 successive slots from the initial transmission slot as indicated by reference numeral 2802. Thereafter, in each nominal repetition, the UE may determine a symbol configured as a downlink symbol in the frame structure 2801 of the TDD system as an invalid symbol and, when valid symbols include one or more successive symbols in one slot, determine actual repetition is configured in the valid symbol and perform uplink transmission as indicated by reference numeral 2803. Accordingly, a total of repK_actual=4 PUSCHs may be actually transmitted. At this time, when repK-RV is configured as 0-2-3-1, an RV in a PUSCH of an actually transmitted first resource 2811 is 0, an RV in a PUSCH of an actually transmitted second resource 2812 is 2, an RV in a PUSCH of an actually transmitted third resource 2813 is 3, and an RV in a PUSCH of an actually transmitted fourth resource 2814 is 1. At this time, only PUSCHs having RV 0 and RV 3 are values which can be decoded by themselves, and in the case of the first resource 2811 and the third resource 2813, the PUSCHs are transmitted only in 3 symbols significantly smaller than the actually configured symbol length (14 symbols), and thus rate matching bit lengths 2821 and 2823 become shorter than bit lengths 2822 and 2824 calculated by the configuration. In the configuration, there may be no PUSCH transmission which can be decoded by itself. In this case, a gain by repetitive transmission cannot be obtained as many as possible and also the reception performance may be exceptionally reduced.

Further, the distance that a signal reaches may increase in proportion to a total of energy used by the UE. That is, when the same amount of data is transmitted, as the UE uses much energy, the data may be transmitted farther. To this end, it is important for the UE to perform transmission for a long time.

Particularly, when the UE performs transmission in an environment in which a signal-to-noise ratio is low, a frequency bandwidth used by the UE may not be important. That is, narrow-band transmission may not influence coverage or may be rather advantageous to coverage expansion.

To this end, it is possible to support sub-PRB transmission making uplink data transmission in units smaller than 1 PRB (12 subcarriers) transmission that is a scheduling unit of conventional NR. For sub-PRB transmission, the disclosure provides a method and an apparatus for calculating a transport block size (TBS).

Meanwhile, in the conventional LTE or NR system, resource allocation is indicated or configured in units of at least PRBs. 1 PRB may be a unit including 12 subcarriers in the frequency domain. When the signal-to-noise ratio (SNR) of the uplink is low, a transmission rate may not be high in proportion to a frequency width (bandwidth) even though there are many frequency allocation resources. Accordingly, in the uplink it may be advantageous to reduce frequency resources allocated to one UE in an aspect of a system capacity.

A resource unit (RU) may be a unit of resource allocation used for sub-PRB allocation, and may be defined as a resource area including M_{symb}^{UL}Mₛₗₒₜ^{UL} symbols in the time domain and M_{sc}^{RU} successive subcarriers in the frequency domain. The resources may or may not be successive in the time axis. For example, M_{sc}^{RU} and M_{symb}^{UL} may be defined as shown in [Table 21] below.

TABLE 21

| Physical | | Modulation | | | | | |
|---|---|---|---|---|---|---|---|
| channel | Δƒ | scheme | M_{SC}^{UL} | M_{SC}^{RU} | Mₛₗₒₜₛ^{UL} | M_{symb}^{UL} | Comment |
| PUSCH | 15 kHz | π/2-BPSK | 12 | 3 | 16 | 7 | 2 out of 3 subcarriers used |
| QPSK | | | | 3 | 8 | | |
| | | | | 6 | 4 | | |

For sub-PRB transmission, the number of sequences of reference signals may vary depending on a modulation order and the number M_{sc}^{RU} of subcarrier units of the resource unit. For example, it may be determined as shown in [Table 22] below.

TABLE 22

| Modulation | | |
|---|---|---|
| Scheme | M_{SC}^{RU} | M_{seq}^{RU} |
| π/2-BPSK | 3 | 16 |
| QPSK | 3 | 12 |
| | 6 | 14 |

The embodiment provides a method and an apparatus for performing sub-PRB transmission in the NR system. When sub-PRB data transmission and reception are performed, a method and an apparatus for calculating the TBS are provided. The embodiment does not specify a network that applies sub-PRB data transmission and reception, but the network can be applied to both ground network communication and satellite network communication. Particularly, in the case of the satellite network, sub-PRB transmission may be applied as a method of recovering a large propagation loss generated due to the long distance between the UE and the satellite.

The first embodiment provides a method and an apparatus for performing sub-PRB transmission in the NR system.

The BS may configure in advance whether sub-PRB transmission is performed and whether resource allocation in units of PRBs is performed in the UE through higher-layer signaling. For example, the configuration can be included in higher-layer signaling including configuration information for satellite network communication. The corresponding configuration may be provided separately for the downlink and the uplink, and may be performed in units of cells or BWPs. For example, data transmission and reception may be performed using resource allocation in units of PRBs in the downlink and data transmission and reception may be performed using resource allocation in units of sub-PRBs in the uplink. This is because a low SNR may be generally generated in the uplink.

Alternatively, in order for the UE to identify whether resource allocation in units of sub-PRBs or resource allocation in units of PRBs is performed, different DCI formats may be used or an indicator indicating resource allocation in units of sub-PRBs may be included in a common DCI format. The indicator may indicate whether resource allocation in units of sub-PRBs is performed to the UE through a bit field of 1 bit.

The number of subcarriers or the number of slots or symbols included in one resource unit may be determined on the basis of subcarrier spacing. For example, information on the number of subcarriers or the number of slots or/and symbols included in one resource unit may be transmitted to the UE through higher-layer signaling or a DCI format or may be predetermined. The configuration information can be configured for each subcarrier spacing. For example, resource allocation may be supported in units of 6 subcarriers in the case of 15 kHz, in units of 3 subcarriers or 6 subcarriers in the case of 30 kHz, in units of 1 subcarrier or 3 subcarriers in the case of 60 kHz, and in units of 1 subcarrier or 2 subcarriers in the case of 120 kHz. That is, candidate values of the minimum number of subcarriers for resource allocation may vary depending on subcarrier spacing, which may be given by, for example, the following table.

TABLE 23

| μ | Δƒ = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

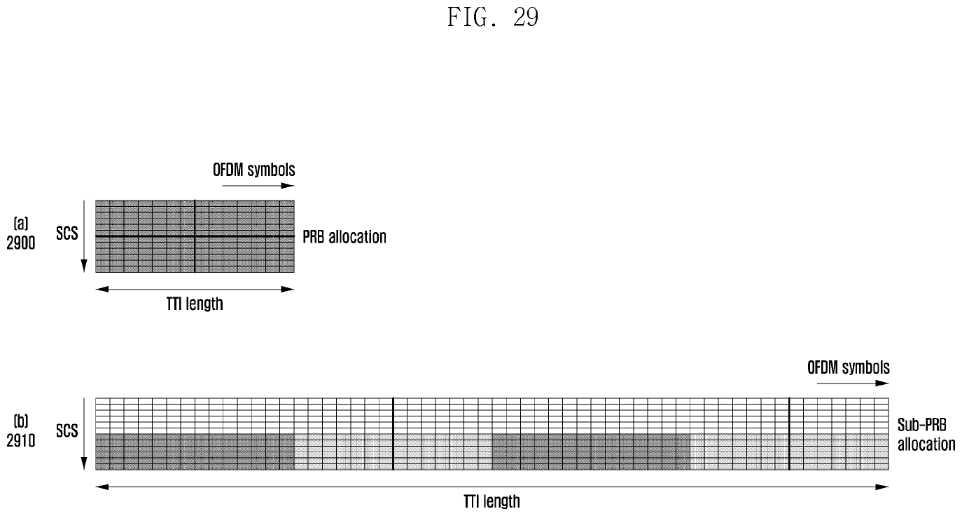

FIG. 29 illustrates an example of resource allocation in units of PRBs and in units of sub-PRBs. FIG. 29A illustrates an example 2900 of resource allocation in units of PRBs. One slot corresponding to 14 symbols is allocated in the time domain, and 1 PRB corresponding to 12 subcarriers is allocated in the frequency domain.

FIG. 29B illustrates an example 2910 of resource allocation in units of sub-PRBs. In the example 2910 of FIG. 29B, M_{sc}^{RU}=6 is the number of subcarriers used for data transmission, M_{symb}^{UL}=14 is the number of slots used for data transmission, and is the number of symbols in one slot. At this time, one PUSCH or PDSCH may be mapped and transmitted in the given resources or one or more given resources.

It is required to determine the symbol location of the DMRS for the PUSCH which the UE transmits when the PUSCH is transmitted. The location of the symbol of the DMRS (that is, a DMRS pattern) may be indicated through a method of indicating one of patterns configured by higher-layer signaling through DMRS information (or DMRS indicator) included in DCI. If only one DMRS pattern is configured through higher-layer signaling, the UE may determine and transmit the DMRS pattern according to a configuration by higher-layer signaling without any indication in DCI (that is, a 0-bit DMRS indicator is included in DCI or no DMRS indicator is included in DCI).

Further, the PUSCH DMRS may not be transmitted by some symbols which are indicated as DL symbols and thus cannot be transmitted among a plurality of slots in which the PUSCH is transmitted. For example, when the PUSCH DMRS is scheduled to transmit the PUSCH over 4 slots and first 7 symbols of the third slot are indicated as DL symbols, the PUSCH DMSR may be configured in the corresponding third slot and indicated transmission may not be performed. In this case, the UE may determine the location on the basis of the first symbol in which the PUSCH is transmitted in the corresponding slot and transmit the PUSCH DMRS. Alternatively, as described above, when the UE may not assume that the PUSCH DMRS is not transmitted due to the DL symbol (that is, when the symbol in which the PUSCH DMRS may be transmitted is determined as the DL symbol, the UE may not assume that PUSCH transmission is configured. In this case, the UE may cancel or skip the PUSCH transmission in the slot or may cancel or skip previous PUSCH transmission) or when the location of the DMRS symbol which may be transmitted is indicated as the DL symbol, the UE may not transmit the corresponding DMRS symbol and may transmit the PUSCH along with only other DMRSs within the corresponding slot.

The second embodiment provides a method and an apparatus for calculating the TBS when sub-PRB transmission is performed. In the conventional NR system, when resources are allocated in minimum PRB units, the TBS may be calculated by applying [Step for calculating TBS in NR system] as described above.

In transmission in units of sub-PRBs, M_{sc}^{UL}, M_{sc}^{RU}, Mₛₗₒₜₛ^{UL}, and M_{symb}^{UL} may be indicated through a configuration using higher-layer signaling or through DCI, or may be values which can be provided along with subcarrier spacing. M_{sc}^{RU} may be the number of subcarriers used for data transmission. Mₛₗₒₜₛ^{UL} is the number of slots used for data transmission, and M_{symb}^{UL} is the number of symbols in one slot. That is, for data mapping, a total of Mₛₗₒₜₛ^{UL}×M_{symb}^{UL} symbols may be used in the time domain, and M_{sc}^{RU} subcarriers may be used in the frequency domain. Accordingly, in the above case, a maximum of Mₛₗₒₜₛ^{UL}−M_{symb}^{UL}×M_{sc}^{RU} REs may be used for data transmission. The number of subcarriers smaller than M_{sc}^{RU} may be used for data transmission according to circumstances (for example, according to a used modulation order).

The following method may be used for the case in which data is transmitted using sub-PRB resource allocation.

In one embodiment, method of calculating TBS is provided when sub-PRB transmission is used in NR system.

Step A1: the number N′_{RE} of REs allocated to PUSCH mapping is calculated within one PRB in allocated resources. The disclosure has been described on the basis of the PUSCH, but the method may also be applied to PDSCH transmission.

N′_{RE} may be calculated as N′_{RE}=N_{sc}^{RB}·N_{symb}^{sh}−N_{DMRS}^{PRB}−Nₛₕ^{PRB}. N_{sc}^{RB} is the number of subcarriers allocated for transmission in units of sub-PRBs (or the number of subcarriers of the sub-PRB RU) and may be smaller than 12. N_{symb}^{sh} may indicate a total number of OFDM (or SC-FDMA) symbols allocated to the PUSCH, and may mean the number of all symbols when transmission is performed over a plurality of slots. N_{DMRS}^{PRB} is the number of REs within the allocated resource area occupied by the DMRS of the CDM group. Nₒₕ^{PRB} is the number of REs occupied by overhead within one PRB configured through higher-layer signaling and may be configured as one of 0, 6, 12, and 18. Thereafter, a total number N_{RE} of REs allocated to the PUSCH may be calculated. N_{RE} is calculated as N_{RE}=min(156,N′_{RE})·n_{PRB}, and n_{PRB} is the number of PRBs allocated to the UE. When N_{RE} is calculated, for example, n_{PRB} is 1, and thus N_{RE}=N′_{RE} Alternatively, when a plurality of RUs are allocated in the frequency axis, nPRB may be the number of RUs in units of sub-PRBs. Further, a value smaller than 156 used in the above equation, for example, 120 may be applied instead of 156. In this case, NRE may be determined as N_{RE}=min(120,N′_{RE})·n_{PRB} or N_{RE}=min(120,N′_{RE}).

In the above equation, N_{DMRS}^{PRB} may be the number of REs within the allocated resource area occupied by DMRSs of the same CDM group, but may be determined using one of the following methods or combinations thereof:
Method 1: the number of REs occupied by actual DMRSs according to a DMRS pattern indicated by DCI within the PUSCH resource area; or
Method 2: N_{DMRS}^{PRB} is the number of REs occupied by DMRSs according to a DMRS pattern configured by higher-layer signaling within the PUSCH resource area. If a plurality of DMRS patterns are configured, the number may be determined as the largest number of DMRS REs or the smallest number of DMRS REs according to a DMRS pattern among the DMRS patterns configured by higher-layer signaling or calculated as an average of the configured patterns. That is, N_{DMRS}^{PRB} may be provided according to the configured patterns or the number of configured patterns.

In the above equation, N_{symb}^{sh} may be a total number of OFDM (or SC-FDMA) symbols allocated to the PUSCH, but may be determined through an indication of the number of symbols within the slot and the number of slots. Alternatively, it may be determined through an indication of a total number of symbols over a plurality of slots.

The method of determining N_{DMRS}^{PRB} and N_{symb}^{sh} may be applied not only to this method but also to another method in the embodiment.

Step A2: the number N_{info} of temporary information bits may be calculated as N_{RE}·R·Qₘ·υ. R is a code rate, Qₘ is a modulation order, and information on the value may be transmitted using an MCS bit field of DCI and a pre-appointed table. υ is the number of allocated layers. If N_{info}≤3824, the TBS may be calculated through step 3 below. In other cases, the TBS may be calculated through step 4.

The method A1 may be replaced with the following method B1 and then applied.

Step B1: the number N′_{RE} of REs allocated to PUSCH mapping is calculated in one slot within allocated resources. N′_{RE} may be calculated as N′_{RE}=N_{sc}^{RB}·N_{symb}^{sh}−N_{DMRS}^{PRB}−Nₒₕ^{PRB}. N_{sc}^{RB} is the number of subcarriers allocated for sub-PRB transmission and may be smaller than 12. N_{symb}^{sh} may be the number of OFDM symbols in one slot allocated for PUSCH transmission. N_{DMRS}^{PRB} is the number of REs within the allocated resource area occupied by DMRSs in the same CDM group. Nₒₕ^{PRB} is the number of REs occupied by overhead within one PRB configured by higher-layer signaling and, when a value configured as one of 0, 6, 12, and 18 is x, may be calculated as

$${N}_{oh}^{PRB} = ⌊ \frac{x}{12} \times {N}_{sc}^{RB} ⌋ .$$

Thereafter, a total number N_{RE} of REs allocated to the PUSCH may be calculated. N_{RE} is calculated as N_{RE}=min(156,N′_{RE})·Mₛₗₒₜₛ^{UL}, and Mₛₗₒₜₛ^{UL} is the number of slots allocated to the UE for PUSCH transmission. When N_{RE} is calculated, for example, n_{PRB} is 1, and thus N_{RE}=N′_{RE}. Alternatively, when a plurality of RUs are allocated in the frequency axis, nPRB may be the number of RUs in units of sub-PRBs. Further, a value smaller than 156 used in the above equation, for example, 120 may be applied instead of 156. In this case, NRE may be determined as N_{RE}=min(120,N′_{RE})·n_{PRB} or N_{RE}=min(120,N′_{RE}).

The method A1 may be replaced with the following method C1 and then applied.

Step C1: the number N_{RE} of REs allocated to PUSCH mapping is calculated. N_{RE} may be calculated as N_{RE}=N_{sc}^{subPRB}·N_{symb}^{sh}−N_{DMRS}^{PRB}−Nₒₕ^{subPRB}. N_{sc}^{subPRB} is the number of subcarriers allocated for sub-PRB transmission and may be smaller than 12. N_{symb}^{sh} may be the number of all OFDM symbols allocated for PUSCH transmission. N_{DMRS}^{PRB} is the number of REs within the allocated resource area occupied by DMRSs in the same CDM group. Nₒₕ^{subPRB} is the number of REs occupied by overhead within the sub-PRB configured by higher-layer signaling and may be a value configured in the higher layer. At this time, Nₒₕ^{subPRB} is a value different from that in the PRB allocation method through higher-layer signaling, and may be a value configured for sub-PRB overhead and smaller than 18. Nₒₕ^{subPRB} may be differently configured according to the number of subcarriers used for sub-PRB transmission. That is, for example, Nₒₕ^{subPRB} may be configured as one of 0, 2, 4, and 8 in sub-PRB transmission using 3 subcarriers, and may be configured as one of 0, 3, 6, and 9 in the case of sub-PRB transmission using 6 subcarriers.

Remaining steps 3 and 4 may be determined according to the conventional NR method and are described below.

Step 3: N′_{info} may be calculated through equations of

$${N}_{info}^{′} = max ( 24 , {2}^{n} \cdot ⌊ \frac{{N}_{info}}{{2}^{n}} ⌋ )$$

and n=max(3,└log₂ N_{info}┘−6). The TBS may be determined as a value closest to N′_{info} among values which are not smaller than N′_{info} in [Table 12A] above.

Step 4: N′_{info} may be calculated through equations of

$${N}_{info}^{′} = max ( 3840 , {2}^{n} \times round ( \frac{{N}_{info} - 24}{{2}^{n}} ) )$$

and n=└log₂(N_{info}−24)┘−5. The TBS may be determined through N′_{info} and [pseudo-code 1] above as shown in Table 12B.

The third embodiment provides a method and an apparatus for additionally supporting a value of the TBS supported by the NR system.
In the conventional NTR system, the following table may show candidate values of the TBS which can be supported when the TBS is equal to or smaller than 3824.

TABLE 24

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 99 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 578 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 192 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2076 |
| 87 | 3104 |
| 88 | 3240 |
| 89 | 3368 |
| 90 | 3496 |
| 91 | 3624 |
| 92 | 3752 |
| 93 | 3824 |

The following table may show candidate values of the TBS which can be used for sub-PRB transmission supported by LTE. Available values of the TBS may vary depending on whether allocated resources are 1 RU, 2 RUs, or 4 RUs. For example, values of 32, 56, 72, 104, 120, 144, 176, and 224 may be supported in the case of 1 RU transmission, values of 88, 144, 176, 224, 256, 328, and 392 may be supported in the case of 2 RU transmission, and values of 328, 408, 504, 600, 712, 808, 936, and 1000 may be supported in the case of 4 RU transmission.

TABLE 25

| | N_{PRB} | | | | | |
|---|---|---|---|---|---|---|
| | 1 | 2 | 3 | 4 | 5 | 6 |
| 0 | 16 | 32 | 56 | 88 | 120 | 152 |
| 1 | 24 | 56 | 88 | 144 | 176 | 208 |
| 2 | 32 | 72 | 144 | 176 | 208 | 256 |
| 3 | 40 | 104 | 176 | 208 | 256 | 328 |
| 4 | 56 | 120 | 208 | 256 | 328 | 408 |
| 5 | 72 | 144 | 224 | 328 | 424 | 504 |
| 6 | 328 | 176 | 256 | 392 | 504 | 600 |
| 7 | 104 | 224 | 328 | 472 | 584 | 712 |
| 8 | 120 | 256 | 392 | 536 | 680 | 808 |
| 9 | 136 | 296 | 456 | 616 | 776 | 936 |
| 10 | 144 | 328 | 504 | 680 | 872 | 1000 |

In comparison between [Table 24] and [Table 25], values of 328, 392, 600, 712, 936, and 1000 are not supported as the TBS in NR. Accordingly, the values cannot be used for the TBS in NR. In this case, services efficiently supported in LTE may be relatively inefficient services in NR.
Accordingly, in [Table 24] providing candidate values of the TBS in NR, one or more values of 328, 392, 600, 712, 936, and 1000 may be additionally included and supported. For example, like in [Table 26] and [Table 27] below, values of 328, 392, 600, 712, 936, and 1000 may be included as candidate values of the TBS to support sub-PRB transmission in [Table 24]. That is, the TBS may be determined using [Table 24] above to calculate the TBS in resource allocation in units of PRBs, and the TBS may be determined using [Table 26] or [Table 27] below to calculate the TBS in resource allocation in units of sub-PRBs. [Table 26] or [Table 27] below are only examples, and at least one of 328, 392, 600, 712, 936, and 1000 may be included in the TBS candidate value table through a method different from the illustrated method.

TABLE 26

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |
| 94 | 328 |
| 95 | 392 |
| 96 | 600 |
| 97 | 712 |
| 98 | 936 |
| 99 | 1000 |

[Table 26] above may be a table of placing newly added values to maintain indexes of the conventional TBS candidate values on the last indexes.

TABLE 27

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 328 |
| 32 | 336 |
| 33 | 352 |
| 34 | 368 |
| 35 | 384 |
| 36 | 392 |
| 37 | 408 |
| 38 | 432 |
| 39 | 456 |
| 40 | 480 |
| 41 | 504 |
| 42 | 528 |
| 43 | 552 |
| 44 | 576 |
| 45 | 600 |
| 46 | 608 |
| 47 | 640 |
| 48 | 672 |
| 49 | 704 |
| 50 | 712 |
| 51 | 736 |
| 52 | 768 |
| 53 | 808 |
| 54 | 848 |
| 55 | 888 |
| 56 | 928 |
| 57 | 936 |
| 58 | 984 |
| 59 | 1000 |
| 60 | 1032 |
| 61 | 1064 |
| 62 | 1128 |
| 63 | 1160 |
| 64 | 1192 |
| 65 | 1224 |
| 66 | 1256 |
| 67 | 1288 |
| 68 | 1320 |
| 69 | 1352 |
| 70 | 1416 |
| 71 | 1480 |
| 72 | 1544 |
| 73 | 1608 |
| 74 | 1672 |
| 75 | 1736 |
| 76 | 1800 |
| 77 | 1864 |
| 78 | 1928 |
| 79 | 2024 |
| 80 | 2088 |
| 81 | 2152 |
| 82 | 2216 |
| 83 | 2280 |
| 84 | 2408 |
| 85 | 2472 |
| 86 | 2536 |
| 87 | 2600 |
| 88 | 2664 |
| 89 | 2728 |
| 90 | 2792 |
| 91 | 2856 |
| 92 | 2976 |
| 93 | 3104 |
| 94 | 3240 |
| 95 | 3368 |
| 96 | 3496 |
| 97 | 3624 |
| 98 | 3752 |
| 99 | 3824 |

[Table 27] above may sequentially arrange values including newly added TBS candidate values and assign indexes.

The fourth embodiment provides scheduling constraint conditions of the BS when sub-PRB transmission is used and a method and an apparatus for receiving control information and data by the UE.

The BS may allocate frequency resources in units of PRBs or sub-PRBs while scheduling uplink and downlink data transmission. The UE can transmit a report indicating that data transmission and reception can be performed using resource allocation in units of sub-PRBs to the BS through UE capability. The UE may also transmit a report indicating that sub-PRB transmission and reception can be performed separately from PDSCH reception in the downlink and PUSCH transmission in the uplink while reporting the UE capability to the BS. Further, the UE can transmit a report indicating whether resource allocation in units of sub-PRBs can be performed according to subcarrier spacing, each cell, and a frequency band (that is, according to FR1 or FR2), and also transmit a report on UE capability including whether the resource allocation is possible according to the number of subcarriers used for sub-PRB transmission.

The BS may configure whether resource allocation in units of sub-PRBs is possible through higher-layer signaling in order to perform resource allocation in units of sub-PRBs. The signaling may be performed by RRC signaling, a MAC CE, or a combination thereof. Further, the BS may configure a frequency domain or a PRB range (or one or more candidate values) to be used for sub-PRB transmission in the UE through higher-layer signaling (RRC signaling, MAC CE, or the like). Accordingly, resource allocation through the DCI may be allocation within the configured frequency domain or/and PRB range, and the size of a frequency resource allocation indicator indicated by the DCI may be determined according to the number of configured PRBs.

When the higher-layer signaling is transmitted, data transmission in units of sub-PRBs can be performed, in which case whether to perform sub-PRB transmission may be indicated through DCI or higher-layer signaling for scheduling the PDSCH or the PUSCH transmitted by the BS. When data transmission and reception in units of sub-PRBs are scheduled through DCI, for example, resource allocation in units of PRBs and resource allocation in units of sub-PRBs may be performed in initial transmission and retransmission of the corresponding PDSCH or the PUSCH. That is, when resource allocation in units of PRBs is performed in initial transmission, retransmission cannot be performed according to resource allocation in units of sub-PRBs. If resource allocation is performed as sub-PRB transmission in initial transmission, there may be no gain according to retransmission when resources are allocated in units of PRBs in retransmission. Since data transmission in units of sub-PRBs may be for a low SNR between the UE and the BS, it may be better to allocate resources in units of sub-PRBs even in retransmission when the SNR is low. Accordingly, when resources are allocated in units of sub-PRBs in initial transmission, the UE may expect allocation of resources in units of sub-PRBs even in retransmission of the same TB. That is, when resources are allocated in units of sub-PRBs in initial transmission, the UE does not expect allocation of resources in units of PRBs in retransmission of the same TB. The disclosure describes that the allocation methods in units of PRBs or sub-PRBs in initial transmission and retransmission may be the same, but allocation methods of initial transmission and retransmission may be different according to circumstances.

When frequency resources are allocated in different allocation units in initial transmission and retransmission (that is, for example, resources are allocated in units of sub-PRBs in initial transmission and resources are allocated in units of PRBs in retransmission or inversely, resources are allocated in units of PRBs in initial transmission and resources are allocated in units of sub-PRBs in retransmission), the UE may omit reception of the corresponding PDSCH or transmission of the PUSCH. This may be to reduce power consumption by not performing unnecessary transmission and reception.

An example of the operation of the UE and the BS implementing the embodiments used in the disclosure is described.

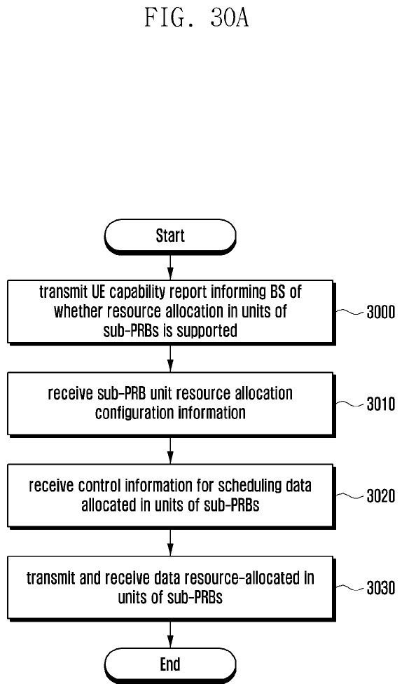

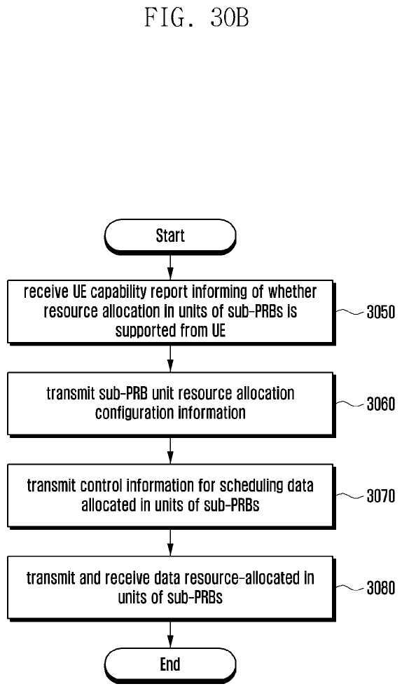

FIG. 30A illustrates an example of the UE operation for implementing the embodiments of the present disclosure. Referring to FIG. 30A, the UE transmits a UE capability report informing that data transmission and reception according to resource allocation in units of sub-PRBs are possible to the BS in operation 3000. The UE capability report may follow a method described in the fourth embodiment. For example, the UE capability report may include whether resource allocation in units of sub-PRBs for each uplink and downlink is supported, whether resource allocation in units of sub-PRBs for each frequency band, each cell and subcarrier spacing is supported, and the like.

Thereafter, the UE receives resource allocation configuration information in units of sub-PRBs from the BS in operation 3010. The configuration information may be received through higher-layer signaling or/and signaling such as a MAC CE, and may include at least information for resource allocation in units of sub-PRBs included in the first and second embodiments and information for calculating the TBS described in the third embodiment. For example, the configuration information may include information on numbers of subcarriers included in one RU, symbols, or/and numbers of slots and also information on the number of REs occupied by overhead for calculating the TBS.

Thereafter, the UE receives control information for scheduling data allocated units of sub-PRBs in operation 3020. The control information may have a DCI format different from that for resource allocation in units of PRBs or/and include an indicator indicating resource allocation in units of sub-PRBs. The UE interprets resource allocation information included in the control information in units of sub-PRBs.

The UE transmits and receives data in resources in units of sub-PRBs according to control information in operation 3030. At this time, for example, when the UE calculates the TBS for transmitting and receiving data, the method disclosed in the second embodiment may be performed.

Each operation described in FIG. 30A does not have to be performed necessarily, and the one or more operations may be performed for data transmission and reception in units of sub-PRBs. Further, the described operations may be omitted or other operations may be added thereto.

FIG. 30B illustrates an example of the BS operation for implementing the embodiments of the present disclosure. Referring to FIG. 30B, the BS receives a UE capability report informing that data transmission and reception according to resource allocation in units of sub-PRBs from the UE in operation 3050. The UE capability report may follow a method described in the fourth embodiment. For example, the UE capability report may include whether resource allocation in units of sub-PRBs for each uplink and downlink is supported, whether resource allocation in units of sub-PRBs for each frequency band, each cell and subcarrier spacing is supported, and the like. The BS may determine whether to configure resource allocation in units of sub-PRBs in the UE in consideration of the UE capability report.

Thereafter, the BS transmits resource allocation configuration information in units of sub-PRBs to the UE in operation 3060. The configuration information may be transmitted through higher-layer signaling or/and signaling such as a MAC CE, and may include at least information for resource allocation in units of sub-PRBs included in the first and second embodiments and information for calculating the TBS described in the third embodiment. For example, the configuration information may include information on numbers of subcarriers included in one RU, symbols, or/and numbers of slots and also information on the number of REs occupied by overhead for calculating the TBS.

Thereafter, the BS transmits control information for scheduling data allocated in units of sub-PRBs in operation 3070. The control information may have a DCI format different from that for resource allocation in units of PRBs or/and include an indicator indicating resource allocation in units of sub-PRBs. Further, the control information may include an MCS bit field, and the BS may configure at least one of the MCS bit field and resource allocation information in consideration of the TBS calculated according to the method disclosed in the second embodiment.

The BS transmits and receives data in resources in units of sub-PRBs according to control information.

Each operation described in FIG. 30B does not have to be performed necessarily, and the one or more operations may be performed for data transmission and reception in units of sub-PRBs. Further, the described operations may be omitted or other operations may be added thereto.

Meanwhile, although the method and the apparatus for allocating resources in unit of sub-PRBs in a communication system and transmitting and receiving data according to various embodiments of the disclosure separately in the first to fourth embodiments for convenience of description, the first to fourth embodiments include the operations associated with each other, and thus at least two embodiments may be combined. Further, the methods according to the respective embodiments do not exclusive, and one or more methods may be combined and performed.

Each of the BS, the satellite, and the UE for implementing embodiments of the disclosure may be a transmission side or a reception side, may include a receiver, a processor, and a transmitter, and may operate according to embodiments of the disclosure.

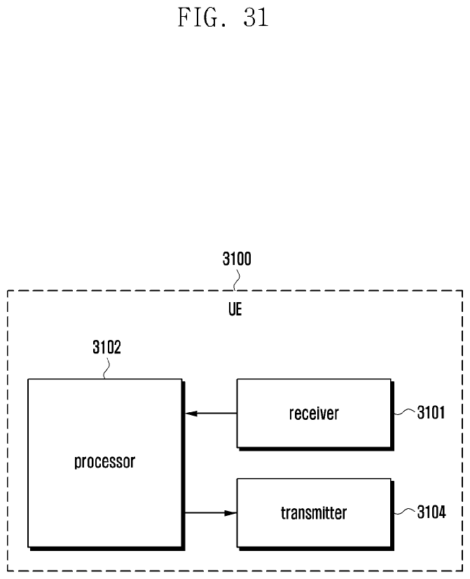

An internal structure of the UE according to various embodiments of the disclosure is described with reference to FIG. 31.

FIG. 31 is a block diagram schematically illustrating the internal structure of the UE according to various embodiments of the present disclosure.

As illustrated in FIG. 31, a UE 3100 may include a receiver 3101, a transmitter 3104, and a processor 3102. The receiver 3101 and the transmitter 3104 may be commonly called a transceiver in embodiments of the disclosure. The transceiver may transmit and receive a signal to and from the BS. The signal may include control information and data. To this end, the transceiver may include an RF transmitter for up-converting and amplifying a frequency of a transmitted signal and an RF receiver for low-noise amplifying a received signal and down-converting a frequency. Further, the transceiver may receive a signal through a radio channel, output the signal to the processor 3102, and transmit the signal output from the processor 3102 through the radio channel. The processor 3102 may control a series of processes to allow the UE 3100 to operate according to the embodiments of the disclosure. For example, the processor 3102 may control the overall operation related to an uplink timing control operation based on TA as described in the first to fourth embodiments. For example, the receiver 3101 may receive a signal from a satellite or a BS on the ground, and the processor 3102 may perform control to transmit a signal to the BS and receive a signal from the BS according to various embodiments of the disclosure. The transmitter 3104 may transmit a determined signal at a determined time point.

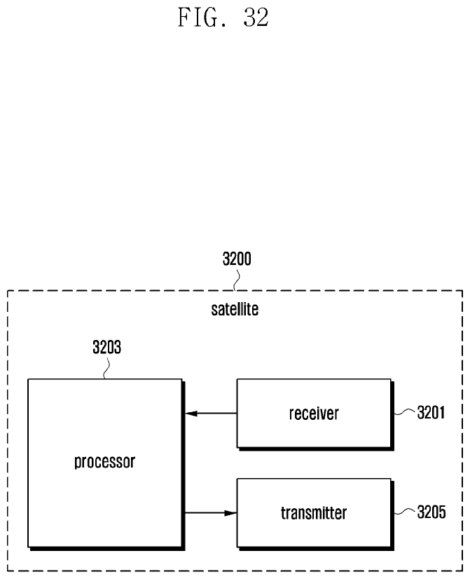

Subsequently, an internal structure of a satellite according to various embodiments of the disclosure is described with reference to FIG. 32.

FIG. 32 is a block diagram schematically illustrating the internal structure of the satellite according to various embodiments of the present disclosure.

As illustrated in FIG. 32, a satellite 3200 may include a receiver 3201, a transmitter 3205, and a processor 3203. Although FIG. 32 illustrates that a receiver, a transmitter, and a processor are implemented in a singular type such as the receiver 3201, the transmitter 3205, and the processor 3203 for convenience of description, the receiver, the transmitter, and the processor can be implemented in a plural type. For example, a receiver and a transmitter for transmitting and receiving a signal to and from the UE and a receiver and a transmitter for transmitting and receiving a signal to and from the BS (and a receiver and a transmitter for transmitting and receiving a signal to and from another satellite) may be separately configured.

The receiver 3201 and the transmitter 3203 may be commonly called a transceiver in embodiments of the disclosure. The transceiver may transmit and receive a signal to and from the UE and the BS. The signal may include control information and data. To this end, the transceiver may include an RF transmitter for up-converting and amplifying a frequency of a transmitted signal and an RF receiver for low-noise amplifying a received signal and down-converting a frequency. Further, the transceiver may receive a signal through a radio channel, output the signal to the processor 3203, and transmit the signal output from the processor 3203 through the radio channel.

The processor 3203 may include a compensator (pre-compensator) for compensating for a frequency offset or Doppler shift and also a device capable of tracking the location through a GPS or the like. The processor 3203 may have a frequency shift function for moving a central frequency of the received signal. The processor 3203 may control a series of processes to operate the satellite, the BS, and the UE according to various embodiments of the disclosure. For example, the processor 3203 may control the overall operation related to an uplink timing control operation based on TA as described in the first to fourth embodiments. For example, the receiver 3201 may determine transmission of TA information to the BS while receiving a PRACH preamble from the UE and transmitting an RAR therefor to the LIE. The transmitter 3205 may transmit the corresponding signals at the determined time point.

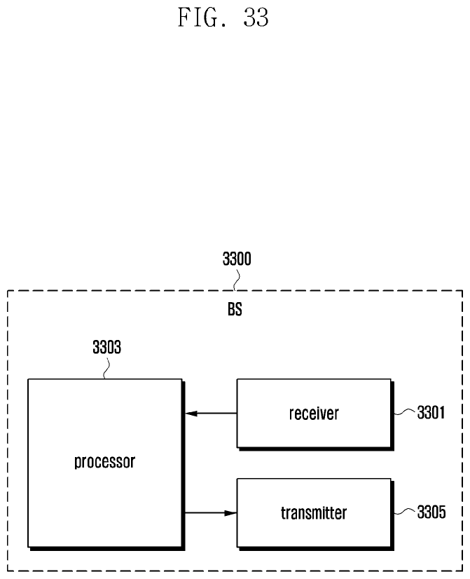

Subsequently, an internal structure of the BS according to various embodiments of the disclosure is described with reference to FIG. 33.

FIG. 33 is a block diagram schematically illustrating the internal structure of the BS according to various embodiments of the present disclosure.

As illustrated in FIG. 33, a BS 3300 may include a receiver 3301, a transmitter 3305, and a processor 3303. The BS 3300 may be a ground BS or a part of the satellite. The receiver 3301 and the transmitter 3305 may be commonly called a transceiver in embodiments of the disclosure. The transceiver may transmit and receive a signal to and from the UE. The signal may include control information and data. To this end, the transceiver may include an RF transmitter for up-converting and amplifying a frequency of a transmitted signal and an RF receiver for low-noise amplifying a received signal and down-converting a frequency. Further, the transceiver may receive a signal through a radio channel, output the signal to the processor 3303, and transmit the signal output from the processor 3303 through the radio channel. The processor 3303 may control a series of processes to operate the BS 3300 according to embodiments of the disclosure. For example, the processor 3303 may control the overall operation related to an uplink timing control operation based on TA as described in the first to fourth embodiments. For example, the processor 3303 may transmit an RAR including TA information.

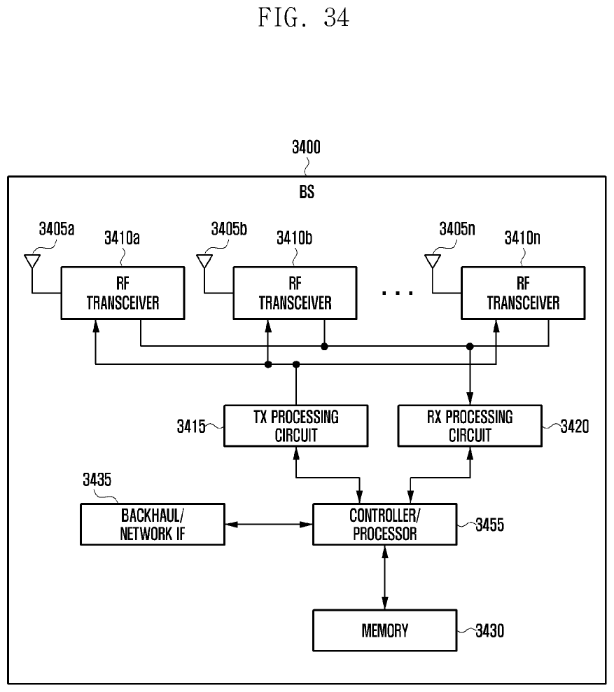

Subsequently, a structure of a BS according to embodiments of the disclosure is described with reference to FIG. 34.

FIG. 34 schematically illustrates the structure of the BS according to embodiments of the present disclosure. The embodiment of the BS illustrated in FIG. 37 is only for an example, and accordingly FIG. 34 does not limit the scope of the disclosure to specific implementation.

As illustrated in FIG. 34, a BS 3400 includes a plurality of antennas 3405a to 3405n, a plurality of RF transceivers 3410a to 3410n, a transmit (TX) processing circuit 3415, and a receive (RX) processing circuit 3420. The BS also includes a controller/processor 3425, a memory 3430, and a backhaul or network interface 3435.

The RF transceivers 3410a to 3410n receive input RF signals such as signals transmitted by the UEs from the antennas 3405a to 3405n in the network. The RF transceivers 3410a to 3410n generate IF or baseband signals by down-converting the input RF signals. The IF or baseband signals are transmitted to the RX processing circuit 3420, and the RX processing circuit 3420 generates processed baseband signals by filtering, decoding, and/or digitalizing the baseband or IF signals. The RX processing circuit 3420 transmits the processed baseband signals to the controller/processor 3425 for additional processing.

The TX processing circuit 3415 receives analog or digital data (such as voice data, web data, email, or interactive video game data) from the controller/processor 3425. The TX processing circuit 3415 generates processed baseband or IF signals by encoding, multiplexing, and/or digitalizing the output baseband data. The RF transceivers 3410a to 3410n receive the output processed baseband or IF signals from the TX processing circuit 3415 and up-convert the baseband or IF signals into RF signals transmitted through the antennas 3405a to 3405n.

The controller/processor 3425 may include one or more processors or other processing devices for controlling the overall operation of the BS. For example, the controller/processor 3425 may control reception of forward channel signals and transmission of backward channel signals by the RF transceivers 3410a to 3410n, the RX processing circuit 3420, and the TX processing circuit 3415 according to the well-known principles. The controller/processor 3425 may support additional functions such as more advanced wireless communication functions.

In various embodiments of the disclosure, for example, the controller/processor 3425 may control the overall operation related to the uplink timing control operation based on TA as described in the first to fourth embodiments.

Further, the controller/processor 3425 may support beamforming or directional routing operations differently weighted to efficiently steer out signals in a direction which the signals output from the plurality of antennas 3405a to 3405n desire. One of the various different functions may be supported by the controller/processor 3425 in the BS.

The controller/processor 3425 may execute programs and other processes residing in the memory 3430 such as an OS. The controller/processor 3425 may move data required by the executed process to the memory 3430 or from the memory 3430 to the outside.

The controller/processor 3425 is connected to the backhaul or network interface 3435. The backhaul or network interface 3435 allows communication of the BS with other devices or systems through a backhaul connection or through the network. The interface 3435 may support communication through appropriate wired or wireless connection(s). For example, when the BS is implemented as a part of the cellular communication system (such as the cellular communication system supporting 5G, LTE, or LTE-A), the interface 3435 may allow communication of the BS with other BSs through the wired or wireless backhaul connection. When the BS is implemented as an access point, the interface 3435 may allow communication of the BS through a wired or wireless local area communication network or through a larger network (such as the Internet) via wired or wireless connection. The interface 3435 includes a proper structure supporting communication through the wired or wireless connection such as an Ethernet or an RF transceiver.

The memory 3430 is connected to the controller/processor 3425. A part of the memory 3430 may include a RAM, and another part of the memory 3430 may include a flash memory or another ROM.

Although FIG. 34 illustrates an example of the BS, various modifications may be made for FIG. 34. For example, the BS may include a predetermined number of components illustrated in FIG. 34. In a specific example, an access point may include a plurality of interfaces 3435, and the controller/processor 3425 may support a routing function of routing data between different network addresses. As another specific example, it is illustrated that a single instance of the TX processing circuit 3415 and a single instance of the RX processing circuit 3420 are included, but the BS may include a plurality of instances (such as 1 instance per RF transceiver). Further, in FIG. 34, various components may be combined, may be additionally divided, or may be omitted, and additional components may be added according to specific needs.

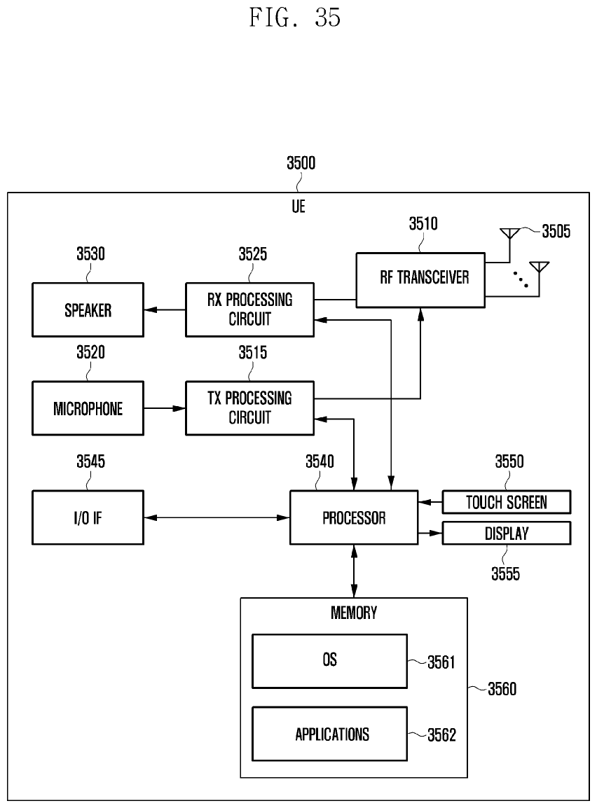

Subsequently, the structure of a UE according to embodiment of the disclosure is described with reference to FIG. 35.

FIG. 35 schematically illustrates the structure of the UE according to embodiments of the present disclosure.

The embodiment of the UE illustrated in FIG. 35 is only for an example, and accordingly FIG. 35 does not limit the scope of the disclosure to specific implementation of the UE.

As illustrated in FIG. 35, a UE 3500 includes an antenna 3505, a radio frequency (RF) transceiver 3510, a TX processing circuit 3515, a microphone 3520, and a receive (RX) processing circuit 3525. The UE also includes a speaker 3530, a processor 3540, an input/output (I/O) interface (IF) 3545, a touch screen 3550, a display 3555, and a memory 3560. The memory 3560 includes an operating system (OS) 3561 and one or more applications 3562.

The RF transceiver 3510 receives an input RF signal transmitted by the BS of the network from the antenna 3505. The RF transceiver 3510 down-converts the input RF signal to generate an intermediate frequency (IF) or baseband signal. The IF or baseband signal is transmitted to the RX processing circuit 3525, and the RX processing circuit 3525 generates a processed baseband signal by filtering, decoding, and/or digitalizing the baseband or IF signals. The RX processing circuit 3525 transmits the processed baseband signal to the speaker 3530 (for voice data) or the processor 3540 (for web browsing data) for additional processing.

The TX processing circuit 3515 receives analog or digital voice data from the microphone 3520 or receives different output baseband data (such as web data, email, or interactive video game data) from the processor 3540. The TX processing circuit 3515 generates a processed baseband or IF signals by encoding, multiplexing, and/or digitalizing the output baseband data. The RF transceiver 3510 receives the output processed baseband or IF signal from the TX processing circuit 3515 and up-converts the baseband or IF signal into an RF signal transmitted through the antenna 3505.

The processor 3540 may include one or more processors or different processing devices and may execute the OS 3561 stored in the memory 3560 in order to control the overall operation of the UE. For example, the processor 3540 may control reception of downlink channel signals and transmission of uplink channel signals by the RF transceiver 3510, the RX processing circuit 3525, and the TX processing circuit 3515 according to the known principles. In some embodiments, the processor 3540 includes at least one micro-processor or micro controller.

The processor 3540 may execute different processes and programs in the memory 3560. When data is required for the executed process, the processor 3540 may move the data to the memory 3560 or from the memory 3560. In some embodiments, the processor 3540 is configured to execute the applications 3562 on the basis of the OS program 3561 or in response to signals received from BSs or an operator. Further, the processor 3540 is connected to the I/O interface 3545, and the I/O interface 3545 provides connection capability for other devices such as laptop computers and handheld computers to the UE. The I/O interface 3545 is a communication path between such accessories and the processor 3540.

The processor 3540 is connected to the touch screen 3550 and the display unit 3555. The operator of the UE may input data into the UE through the touch screen 3550. The display 3555 may be a liquid crystal display, an organic light emitting diode display, or another display capable of rendering text and/or at least limited graphics from web sites.

The memory 3560 is connected to the processor 3540. A part of the memory 3560 may include a random access memory (RAM), and the remaining parts of the memory 3560 may include a flash memory or another read-only memory (ROM).

Although FIG. 35 illustrates an example of the UE, various modifications may be made for FIG. 35. For example, in FIG. 35, various components may be combined, may be additionally divided, or may be omitted, or other components may be added according to specific needs. Further, in a specific example, the processor 3540 may be divided into a plurality of processors such as one or more central processing units (CPUs) and one or more graphics processing units (GPUs). Further, in FIG. 35, although the UE is configured as a mobile phone or a smartphone, the UE may be configured to operate as other types of mobile or fixed devices.

Meanwhile, embodiments of the disclosure disclosed in the specifications and drawings are presented only for specific examples to easily describe technical content of the disclosure and help understanding of the disclosure, but do not limit the scope of the disclosure. That is, it is obvious to those skilled in the art to which the disclosure belongs that other modifications based on the technical idea of the disclosure can be achieved. Further, respective embodiments may be combined and realized as necessary. For example, the first embodiment and the second embodiment may be combined and applied. Further, embodiments of the disclosure may be applied to the LTE system and the 5G system through other modified examples based on the technical idea of the embodiments.

Although the disclosure is described with reference to embodiments, various changes and modifications may be proposed to those skilled in the art. The disclosure intends to include changes and modifications existing within the scope of the appended claims. Any of the detailed description of the document should not be read that a specific element, process, or function is a necessary element which should be included in the scope of the claims. Patented scope of the subject is defined by the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a communication system, the method comprising:
receiving, from a base station, configuration information on a sub physical resource block (sub-PRB) based transmission, the configuration information including at least one of a number of subcarriers for a resource unit or a number of slots in the resource unit;
receiving, from the base station, downlink control information scheduling uplink data associated with the sub-PRB based transmission;
obtaining a transport block size (TBS) corresponding to the uplink data based on the configuration information; and
transmitting, to the base station, the uplink data on a physical uplink shared channel (PUSCH),
wherein the number of subcarriers for the resource unit is smaller than 12.

2. The method of claim 1, wherein the TBS is obtained based on a number of resource elements (REs) N_{RE}, and
wherein the number of REs is identified based on following equation:
N_{RE}=min(120,N′_{RE})·n_{PRB},
where n_{PRB} is a number of the resource unit, and N′_{RE} corresponds to a calculated number of REs based on the configuration information.

3. The method of claim 1, wherein the TBS is obtained based on a calculated number of REs N′_{RE}, and
wherein the calculated number of REs is identified based on a number of REs for overhead that is obtained by using the number of subcarriers for the resource unit.

4. The method of claim 1, wherein the TBS is obtained based on a TBS table that includes at least one of values including 328, 392, 600, 712, 936, or 1000.

5. The method of claim 1, further comprising:
transmitting, to the base station, capability information on the sub-PRB based transmission,
wherein the capability information includes an indicator indicating whether the terminal supports the sub-PRB based transmission or not.

6. A method performed by a base station in a communication system, the method comprising:
transmitting, to a terminal, configuration information on a sub physical resource block (sub-PRB) based transmission, the configuration information including at least one of a number of subcarriers for a resource unit or a number of slots in the resource unit;
identifying a transport block size (TBS) corresponding to uplink data based on the configuration information;
transmitting, to the terminal, downlink control information scheduling the uplink data associated with the sub-PRB based transmission; and
receiving, from the terminal, the uplink data on a physical uplink shared channel (PUSCH),
wherein the number of subcarriers for the resource unit is smaller than 12.

7. The method of claim 6, wherein the TBS is identified based on a number of resource elements (REs) N_{RE}, and
wherein the number of REs is identified based on following equation:
N_{RE}=min(120,N′_{RE})·n_{PRB},
where n_{PRB} is a number of the resource unit, and N′_{RE} corresponds to a calculated number of REs based on the configuration information.

8. The method of claim 6, wherein the TBS is identified based on a calculated number of REs N′_{RE}, and
wherein the calculated number of REs is identified based on a number of REs for overhead that is obtained by using the number of subcarriers for the resource unit.

9. The method of claim 6, wherein the TBS is identified based on a TBS table that includes at least one of values including 328, 392, 600, 712, 936, or 1000.

10. The method of claim 6, further comprising:
receiving, from the terminal, capability information on the sub-PRB based transmission,
wherein the capability information includes an indicator indicating whether the terminal supports the sub-PRB based transmission or not.

11. A terminal in a communication system, the terminal comprising:
a transceiver; and
a controller coupled with the transceiver and configured to:
receive, from a base station, configuration information on a sub physical resource block (sub-PRB) based transmission, the configuration information including at least one of a number of subcarriers for a resource unit or a number of slots in the resource unit,
receive, from the base station, downlink control information scheduling uplink data associated with the sub-PRB based transmission,
obtain a transport block size (TBS) corresponding to the uplink data based on the configuration information, and
transmit, to the base station, the uplink data on a physical uplink shared channel (PUSCH),
wherein the number of subcarriers for the resource unit is smaller than 12.

12. The terminal of claim 11, wherein the TBS is obtained based on a number of resource elements (REs) N_{RE}, and
wherein the number of REs is identified based on following equation:
N_{RE}=min(120,N′_{RE})·n_{PRB},
where n_{PRB} is a number of the resource unit, and N′_{RE} corresponds to a calculated number of REs based on the configuration information.

13. The terminal of claim 11, wherein the TBS is obtained based on a calculated number of REs N′_{RE}, and
wherein the calculated number of REs is identified based on a number of REs for overhead that is obtained by using the number of subcarriers for the resource unit.

14. The terminal of claim 11, wherein the TBS is obtained based on a TBS table that includes at least one of values including 328, 392, 600, 712, 936, or 1000.

15. The terminal of claim 11, wherein the controller is further configured to transmit, to the base station, capability information on the sub-PRB based transmission,
wherein the capability information includes an indicator indicating whether the terminal supports the sub-PRB based transmission or not.

16. Abase station in a communication system, the base station comprising:
a transceiver; and
a controller coupled with the transceiver and configured to:
transmit, to a terminal, configuration information on a sub physical resource block (sub-PRB) based transmission, the configuration information including at least one of a number of subcarriers for a resource unit or a number of slots in the resource unit,
identify a transport block size (TBS) corresponding to uplink data based on the configuration information,
transmit, to the terminal, downlink control information scheduling the uplink data associated with the sub-PRB based transmission, and
receive, from the terminal, the uplink data on a physical uplink shared channel (PUSCH),
wherein the number of subcarriers for the resource unit is smaller than 12.

17. The base station of claim 16, wherein the TBS is identified based on a number of resource elements (REs) N_{RE}, and
wherein the number of REs is identified based on following equation:
N_{RE}=min(120,N′_{RE})·n_{PRB},
where n_{PRB} is a number of the resource unit, and N′_{RE} corresponds to a calculated number of REs based on the configuration information.

18. The base station of claim 16, wherein the TBS is identified based on a calculated number of REs N′_{RE}, and
wherein the calculated number of REs is identified based on a number of REs for overhead that is obtained by using the number of subcarriers for the resource unit.

19. The base station of claim 16, wherein the TBS is identified based on a TBS table that includes at least one of values including 328, 392, 600, 712, 936, or 1000.

20. The base station of claim 16, wherein the controller is further configured to receive, from the terminal, capability information on the sub-PRB based transmission,
wherein the capability information includes an indicator indicating whether the terminal supports the sub-PRB based transmission or not.
